(19) United States
(12) Patent Application Publication
(10) Pub. No.: US 2019/0014040 A1
(43) Pub. Date: Jan. 10, 2019

(54) EDGE NETWORK NODE AND METHOD FOR CONFIGURING A SERVICE THEREIN

(71) Applicant: ALE USA INC., Calabasas, CA (US)

(72) Inventors: Sanjeeva Reddy YERRAPUREDDY, Calabasas, CA (US); Pramoda NALLUR, Calabasas, CA (US); Sahil DIGHE, Calabasas, CA (US)

(21) Appl. No.: 16/131,338

(22) Filed: Sep. 14, 2018

Related U.S. Application Data
(63) Continuation of application No. PCT/US16/24878, filed on Mar. 30, 2016.

(51) Int. Cl. H04L 12/713; H04L 12/46; H04L 12/715; H04L 12/741

(52) U.S. Cl. CPC H04L 45/586; H04L 12/4633; H04L 45/54; H04L 45/04; H04L 12/4641

(57) ABSTRACT

An edge network node and a method of configuring a service are disclosed. A virtualized routing and forwarding (VRF) instance is defined for a customer at the edge network node. The edge network node also defines a service identifier. The edge network node associates the VRF instance with the service identifier and with a routing table entry. The routing table entry comprises a set of destination IP addresses and a backbone IP address, which may be an address of a peer edge network node. When the edge network node receives a packet from the customer, it encapsulates the packet in a tunnel and forwards it on a backbone network toward the peer edge network node. The edge network node may associate a plurality of routing table entries with a service, may define a plurality of services for the customer and may define services for a plurality of customers.

### CROSS-REFERENCE TO RELATED APPLICATION(S)

This United States Non-Provisional Patent Application is a continuation application of and claims priority from International Application Serial No. PCT/US2016/024878, filed on Mar. 30, 2016, the entire content of which is incorporated herein by reference.

### FIELD

The present technology relates to nodes and methods for configuring a service. In particular, the nodes and methods aim at associating routing and service information at nodes provided at the edge of a backbone network.

### BACKGROUND

A number of industry standards provide protocols allowing network providers to create and configure backbone networks, allowing their customers to interconnect their own virtual local area networks (VLAN), defined in plural sites or geographical locations, through tunnels of those backbone networks. For example, a given customer may deploy VLANs over two (2) or more sites, each site including a plurality of customer equipment (CE) devices. Exchange of data packets between CEs located at distinct sites rely on the transport of those packets through tunnels in the backbone network. Operators provide connections to their backbone network through so-called edge network nodes that, in turn, become tunnelling end points.

One example of such standard is the IEEE 802.1aq standard that defines a Shortest Path Bridging-MACinMAC (SPB-M) protocol. SPB-M provides customers with layer 2 (L2) virtual private network (VPN) service functionality across a provider's backbone network. Other suitable technologies include virtual extensible local area network (VxLAN), virtual private local area network service (VPLS) and the like.

A given customer may have sites located in areas served by, for example, a SPB backbone network and other sites served by, for example, a VPLS backbone network. The various backbone network technologies do not share a common framework. It is not possible, for example, to support end-to-end tunneling between sites connected through disjoint backbone technologies.

Improvements may therefore be desirable, in particular, improvements aiming at providing a common framework allowing the connection of customer sites through various backbone technologies.

### SUMMARY

It is an object of present technology to provide improvements, in particular improvements aiming at associating routing and service information at nodes provided at the edge of a backbone network.

The present technology arises from an observation made by the inventors that creating, in an edge network node, an IP interface endpoint for a service may be relied upon to provide service abstraction, whereby IP services are rendered independent from underlying layer 2 transport protocols. Virtual private network (VPN) tunnels leading to a peer edge network node are created. In some embodiments, tunnels may be created for routing packets over a shortest path bridging (SPB) service. In some other embodiments, tunnels may be created for routing packets over a virtual extensible local area network (VxLAN). In yet some further embodiments, tunnels may be created for routing packets over a virtual private local area network service (VPLS). In some embodiments, the present technology may be adapted to support equal cost multi path (ECMP) routing. In the same or other embodiments, the present technology may be adapted to support virtual router redundancy protocol (VRRP). The edge network node may for example be a backbone edge bridge (BEB) or a virtual tunnel end point (VTEP), or may combine the features of a BEB and of a VTEP. In some embodiments, the edge network node may comprise a service provisioning interface and a service manager allowing to define service information and to activate or deactivate a service.

Thus, in one aspect, various implementations of the present technology provide a method of configuring a service at an edge network node, comprising:
defining, at the edge network node, a first virtualized routing and forwarding (VRF) instance, the first VRF instance being defined for a first customer;
defining, at the edge network node, a first service identifier; and
associating, at the edge network node, (i) the first VRF instance with (ii) the first service identifier and with (iii) a first routing table entry, the first routing table entry comprising a first set of destination IP addresses and a first backbone IP address, the first backbone IP address being an address of a first peer edge network node.

In some implementations, the method further comprises:
associating, at the edge network node, (i) the first VRF instance with (ii) the first service identifier, with (iii) the first routing table entry and with (iv) a second routing table entry, the second routing table entry comprising a second set of destination IP addresses and a second backbone IP address, the second backbone IP address being an address of a second peer edge network node.

In some further implementations, the method further comprises:
defining, at the edge network node, a second service identifier; and
associating, at the edge network node, (i) the first VRF instance with (ii) the second service identifier and with (iii) a third routing table entry, the third routing table entry comprising the first set of destination IP addresses and a third backbone IP address, the third backbone IP address being an address of the first peer edge network node.

In some implementations, the method further comprises
defining, at the edge network node, a third service identifier; and
associating, at the edge network node, (i) the first VRF instance with (ii) the third service identifier and with (iii) a fourth routing table entry, the fourth routing table entry comprising a third set of destination IP addresses and a fourth backbone IP address, the fourth backbone IP address being an address of a third peer edge network node.

In some further implementations, the method further comprises:
associating, at the edge network node, (i) the first VRF instance with (ii) the first service identifier, with (iii) the first routing table entry and with (iv) a fifth routing table entry, the fifth routing table entry comprising a fourth set of destination IP addresses and the first backbone IP address.

In some implementations, the method further comprises:
defining, at the edge network node, a second VRF instance, the second VRF instance being defined for a second customer;
defining, at the edge network node, a fourth service identifier; and
associating, at the edge network node, (i) the second VRF instance with (ii) the fourth service identifier and with (iii) a sixth routing table entry, the sixth routing table entry comprising a fifth set of destination IP addresses and a fifth backbone IP address, the fifth backbone IP address being an address of the first peer edge network node.

In another aspect, various implementations of the present technology provide a method of configuring an Internet access service at an edge network node, comprising:
defining, at the edge network node, a fifth service identifier and a sixth service identifier;
associating, at the edge network node, (i) the fifth service identifier with (ii) a first service access port for a third customer;
defining, at the edge network node, a fourth VRF instance, the fourth VRF instance being defined for a fourth customer; and
associating, at the edge network node, (i) the fourth VRF instance with (ii) the sixth service identifier, with (iii) a second service access port for the fourth customer and with (iv) a seventh routing table entry, the seventh routing table entry comprising a sixth set of destination IP addresses and a first gateway address of a first Internet service provider.

In another aspect, various implementations of the present technology provide a method of configuring an Internet access service at an edge network node, comprising:
defining, at the edge network node, a fifth virtualized routing and forwarding (VRF) instance, the fifth VRF instance being defined for a fifth customer;
defining, at the edge network node, a sixth VRF instance, the sixth VRF instance being defined for a sixth customer;
defining, at the edge network node, a seventh service identifier and an eighth service identifier;
associating, at the edge network node, (i) the fifth VRF instance with (ii) the seventh service identifier, with (iii) a third service access port for the fifth customer, and with (iv) a ninth routing table entry, the ninth routing table entry comprising a seventh set of destination IP addresses and a second gateway address of a second Internet service provider;
associating, at the edge network node, (i) the sixth VRF instance with (ii) the eighth service identifier, with (iii) a fourth service access port for the sixth customer, and with (iv) a tenth routing table entry, the tenth routing table entry comprising an eighth set of destination IP addresses and a third gateway address of one of the second Internet service provider and a third Internet service provider;
configuring, at the edge network node, a first virtual IP address for the fifth VRF and a second virtual IP address for the sixth VRF;
assigning, at the edge network node, one of the edge network node and a fourth peer edge network node as a first master for the fifth VRF; and
assigning, at the edge network node, one of the edge network node and the fourth peer edge network node as a second master for the sixth VRF.

In some implementations, the method further comprises:
receiving, at the edge network node, from the first customer, a first outgoing packet comprising a first header, the first header comprising a first layer 3 destination address (DA) designating a first distant node;
mapping, at the edge network node, the first layer 3 DA to the first set of destination IP addresses;
encapsulating, at the edge network node, the first outgoing packet in a first outgoing tunnel packet by adding a first outer header to the first outgoing packet, the first outer header comprising the first service identifier and
sending the first outgoing tunnel packet, from the edge network node, over a backbone network in accordance with the first service identifier.

In some further implementations, the method further comprises:
if the first service identifier designates is a layer 2 backbone network, acquiring, at the edge network node, a first layer 2 address corresponding to the first backbone IP address, and inserting the first layer 2 address in the first outer header;
if the first service identifier designates a layer 3 backbone network, inserting the first backbone IP address in the first outer header.

In some further implementations, the method further comprises:
receiving, at the edge network node, from the first customer, a second outgoing packet comprising a second header, the second header comprising a second layer 3 DA designating a second distant node;
mapping, at the edge network node, the second layer 3 DA to one of the first and second sets of destination IP addresses to select one of the first and second backbone IP addresses;
if the first service identifier designates a layer 3 backbone network, defining, at the edge network node, a second outer header comprising (i) the first service identifier and (ii) the selected one of the first and second backbone IP addresses;
if the first service identifier designates a layer 2 backbone network, acquiring, at the edge network node, a first layer 2 address corresponding to selected one of the first and second backbone IP addresses, and defining, at the edge network node, a second outer header comprising (i) the first service identifier and (ii) the first layer 2 address;
encapsulating, at the edge network node, the second outgoing packet in a second outgoing tunnel packet by adding the second outer header to the second outgoing packet; and
sending the second outgoing tunnel packet, from the edge network node, over the backbone network.

In some implementations, the method of further comprises:
receiving, at the edge network node, from the first customer, a third outgoing packet comprising a third header, the third header comprising a third layer 3 DA designating a third distant node;
mapping, at the edge network node, the third layer 3 DA to the first set of destination IP addresses;
using, at the edge network node, a load balancing protocol to select one of the first and second service identifiers and to select a corresponding one of the first and third backbone IP addresses;
if the selected service identifier designates a layer 3 backbone network, defining, at the edge network node, a third outer header comprising (i) the selected one of the first and third backbone IP addresses and (ii) the selected one of the first and second service identifiers;
if the selected service identifier designates a layer 2 backbone network, acquiring, at the edge network node, a third layer 2 address corresponding to the selected one of the first and third backbone IP addresses, and defining, at the edge network node, a third outer header comprising (i) the third layer 2 address and (ii) the selected one of the first and second service identifiers;
encapsulating, at the edge network node, the third outgoing packet in a third outgoing tunnel packet by adding the third outer header to the third outgoing packet; and
sending the third outgoing tunnel packet, from the edge network node, over a backbone network in accordance with the selected service identifier.

In some further implementations, the method further comprises:
receiving, at the edge network node, from the first customer, a fourth outgoing packet comprising a fourth header, the fourth header comprising a fourth layer 3 DA designating a fourth distant node;
mapping, at the edge network node, the fourth layer 3 DA to one of the first and third sets of destination IP addresses to select one of the first and fourth backbone IP addresses and to select a corresponding one of the first and third service identifiers;
if the selected service identifier designates a layer 3 backbone network, defining, at the edge network node, a fourth outer header comprising (i) the selected service identifier and (ii) the selected one of the first and fourth backbone IP addresses;
if the selected service identifier designates a layer 2 backbone network, acquiring, at the edge network node, a fourth layer 2 address corresponding to selected one of the first and fourth backbone IP addresses, and defining, at the edge network node, a fourth outer header comprising (i) the selected service identifier and (ii) the fourth layer 2 address;
encapsulating, at the edge network node, the fourth outgoing packet in a fourth outgoing tunnel packet by adding the fourth outer header to the fourth outgoing packet; and
sending the fourth outgoing tunnel packet, from the edge network node, over a backbone network in accordance with the selected service identifier.

In some implementations, the method further comprises:
receiving, at the edge network node, on the first service access port for the third customer, a fifth outgoing packet comprising a fifth header, the fifth header comprising a first layer 2 DA and a fifth layer 3 DA designating a first Internet resource;
associating, at the edge network node, the fifth outgoing packet to the fifth service identifier based on the first service access port;
if the fifth service identifier designates a layer 3 backbone network, defining, at the edge network node, a fifth outer header comprising (i) the fifth service identifier and (ii) the fifth layer 3 DA;
if the fifth service identifier designates a layer 2 backbone network, defining, at the edge network node, a fifth outer header comprising (i) the fifth service identifier and (ii) the first layer 2 DA, encapsulating, at the edge network node, the fifth outgoing packet in a fifth outgoing tunnel packet by adding the fifth outer header to the fifth outgoing packet, and sending the fifth outgoing tunnel packet, from the edge network node, over a backbone network in accordance with the fifth service identifier.

In some further implementations, the method of further comprises:
receiving, at the edge network node, on the second service access port for the fourth customer, a sixth outgoing packet comprising a sixth header, the sixth header comprising a sixth layer 3 DA designating a second Internet resource;
associating, at the edge network node, the sixth outgoing packet to the sixth service identifier based on the second service access port;
verifying, at the edge network node, that the sixth layer 3 DA maps to the sixth set of destination IP addresses; and
if the sixth layer 3 DA maps to the sixth set of destination IP addresses, routing the sixth outgoing packet based on the sixth layer 3 DA.

In some implementations, the method further comprises:
receiving, at the edge network node, on the third service access port for the fifth customer, a seventh outgoing packet comprising a seventh header, the seventh header comprising a second layer 2 DA and a seventh layer 3 DA designating a third Internet resource;
associating, at the edge network node, the seventh outgoing packet to the seventh service identifier based on the third service access port;
if edge network node is the first master for the fifth VRF, verifying, at the edge network node, that the seventh layer 3 DA maps to the seventh set of destination IP addresses and, if the seventh layer 3 DA maps to the seventh set of destination IP addresses, routing the seventh outgoing packet based on the seventh layer 3 DA;
if the fourth peer edge network node is the first master for the fifth VRF and if the seventh service identifier designates a layer 3 backbone network, defining, at the edge network node, a sixth outer header comprising (i) the seventh service identifier and (ii) the seventh layer 3 DA, encapsulating, at the edge network node, the sixth outgoing packet in a sixth outgoing tunnel packet by adding the sixth outer header to the sixth outgoing packet, and sending the sixth outgoing tunnel packet, from the edge network node, over a backbone network in accordance with the seventh service identifier;
if the fourth peer edge network node is the first master for the fifth VRF and if the seventh service identifier designates a layer 2 backbone network, defining, at the edge network node, a sixth outer header comprising (i) the seventh service identifier and (ii) the second layer 2 DA, encapsulating, at the edge network node, the sixth outgoing packet in a sixth outgoing tunnel packet by adding the sixth outer header to the sixth outgoing packet, and sending the sixth outgoing tunnel packet, from the edge network node, over a backbone network in accordance with the seventh service identifier.

In some further implementations, the method further comprises:
detecting, at the edge network node, that the fourth peer edge network node is not available;
assigning, at the edge network node, the edge network node as the first master for the fifth VRF; and
assigning, at the edge network node, the edge network node as the second master for the sixth VRF.

In other aspects, various implementations of the present technology provide an edge network node, comprising:
a local port configured for exchanging packets with a first site of a first customer;
a network port configured for sending packets over a backbone network;
a memory device configured to store service information and routing information;
a processor operatively connected with the local port and with the network port, the processor being operative to read and write into the memory device, the processor being configured to:
define a first virtualized routing and forwarding (VRF) instance, the first VRF instance being defined for the first customer;
define a first service identifier; and
store in the memory device an association of (i) the first VRF instance with (ii) the first service identifier and with (iii) a first routing table entry, the first routing table entry comprising a first set of destination IP addresses and a first backbone IP address, the first backbone IP address being an address of a first peer edge network node

In some implementations of the edge network, the processor is further configured to:
locate, in an outgoing packet received at the local port, a first header comprising a first layer 3 destination address (DA) designating a first distant node;
associate the first outgoing packet with the first VRF instance by mapping the first layer 3 DA to the first set of destination IP addresses;
encapsulate the first outgoing packet in a first outgoing tunnel packet by adding a first outer header to the first outgoing packet, the first outer header comprising the first service identifier and the first backbone IP address;
request the network port to send the first outgoing tunnel packet over a backbone network in accordance with the first service identifier.

In some implementations of the edge network, the processor is further configured to:
acquire a first layer 2 address corresponding to the first backbone IP address;
locate, in an outgoing packet received at the local port, a first header comprising a first layer 3 destination address (DA) designating a first distant node;
associate the first outgoing packet with the first VRF instance by mapping the first layer 3 DA to the first set of destination IP addresses;
encapsulate the first outgoing packet in a first outgoing tunnel packet by adding a first outer header to the first outgoing packet, the first outer header comprising the first service identifier and the first layer 2 address;
request the network port to send the first outgoing tunnel packet over a backbone network in accordance with the first service identifier.

In some further implementations, the edge network node further comprises:
a service provisioning interface;
a service manager operable to receive and parse service information from the service provisioning interface and to send the service information to the processor.

In some implementations of the edge network node, the service provisioning interface is connected to an operator interface.

In some further implementations of the edge network node, the service manager is configured to inform the processor of a service activation and of a service deactivation.

In some implementations of the edge network node, the service manager is configured to delete any part of the service information and to inform the processor of the deletion.

In some further implementations of the edge network node, the processor is further configured to define a service access port and to associate a packet received on this service access port to a corresponding service instance.

In the context of the present specification, unless expressly provided otherwise, a “customer equipment” and an “edge network node” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “memory device” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first routing table entry” and “third routing table entry” is not intended to imply any particular order, type, chronology, hierarchy or ranking (for example) of/between the routing table entries, nor is their use (by itself) intended imply that any “second routing table entry” must necessarily exist in any given situation. Yet as another example, it should be understood that, the use of the terms “first gateway address” and “third gateway address” is not intended to imply, unless specified otherwise, any particular order, type, chronology, hierarchy or ranking (for example) of/between the suggested gateway address, nor is their use (by itself) intended imply that any “second gateway address” must necessarily exist in any given situation. Further, as is discussed herein in other contexts, reference to a “first” element and a “second” element does not preclude the two elements from being the same actual real-world element. Thus, for example, in some instances, a “first” gateway address and a “second” gateway address may be the same IP address, in other cases they may be different IP addresses.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a network suitable for implementing the present technology and/or being used in conjunction with implementations of the present technology;

FIG. 2 is an internal block diagram of a routing decision process within an edge network node;

FIG. 3 is an illustration of a service architecture implemented in an edge network node;

FIG. 4 is a diagram showing an application of the network of FIG. 1 for provision of a router gateway;

FIG. 5 is a diagram showing an application of the network of FIG. 1 for provision of a Virtual Router Redundancy Protocol;

FIG. 6 is a diagram showing an application of the network of FIG. 1 using a load balancing protocol;

FIG. 7 is a diagram illustrating a creation of multiple tunnels; and

FIG. 8 is a diagram illustrating routing between different service types.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any network diagrams herein represent conceptual views of illustrative networks embodying the principles of the present technology.

The functions of the various elements shown in the figures, including any functional block labeled as a “processor”, may be provided through the use of dedicated hardware as well as hardware capable of executing software in association with appropriate software. The software for execution by the processor may comprise machine executable code stored on a non-transitory storage medium. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

The following acronyms are used in the present disclosure:

ARP Address Resolution Protocol

BEB Backbone Edge Bridge

BFD Bidirectional Forwarding

BGP Border Gateway Protocol

CE Customer Equipment

DA Destination Address

ECMP Equal Cost Multi Paths

IBGP Internal Border Gateway Protocol

IEEE 802.1aq SPB specification

IP Internet Protocol

IPv4IP version 4

IPv6IP version 6

ISID Instance Identifier (for a backbone service in IEEE 802 1ah)

ISP Internet service provider

IS-IS Intermediate System to Intermediate System

L2 Layer 2

L3 Layer 3

LAN Local Area Network

LPM Longest Prefix Match

MAC Media Access Control

OSPF Open Shortest Path First

PBB Provider Backbone Bridge

RIP Routing Information Protocol

SA Source Address

SPB Shortest Path Bridging (i.e. the IEEE 802.1aq protocol)

SPB-M Shortest Path Bridging-MACinMAC

TLV Type Length Value

TTI Tunnel Termination Interface

TTL Time To Live

VLAN Virtual LAN

VMAC Virtual MAC

VP Virtual Port

VPLS Virtual Private LAN Services

VPN Virtual Private Network

VRF Virtualized Routing And Forwarding

VRRP Virtual Router Redundancy Protocol

VTEP Virtual Tunnel End Point

VxLAN Virtual Extensible LAN

The following definitions are used in the present disclosure:
Outgoing packet A packet to be forwarded by from edge network node, toward a layer 2 backbone network or toward the Internet, on behalf of a customer equipment device
Incoming packet A packet received at an edge network node, from a layer 2 backbone network, for delivery to a customer equipment device

Generally stated, the present technology proposes creating an internet protocol (IP) interface endpoint on a service, forming a layer 3 (L3) virtual private network (VPN). L3 VPN interfaces provide next-hop interfaces for VPN routes. This technology provides a desired flexibly to create multiple VPN tunnels leading to other edge network nodes that are configured in the same service. Because this L3 VPN interface behaves like a regular IP interface, it becomes possible to extend all IP functionalities to the service domain while still retaining a common virtualized routing and forwarding (VRF) context for routing/forwarding purposes. Service abstraction is obtained in that IP services are independent from the type of transport protocol on which the VPN interface is built.

The present technology is compatible with the use of common routing protocols such as, for example, open shortest path first (OSPF), routing information protocol (RIP), border gateway (BGP) and the like, on an L3 VPN interface, as in the case of a regular IP interface. In turn, it becomes possible to run bidirectional forwarding (BFD) on L3 VPN interfaces in conjunction with routing protocols for faster failure detection of remote peers, helping to improve the routing convergence time. This gives flexibility for an edge network node to act as a default router gateway on a service.

The present technology further gives flexibility to run a virtual router redundancy protocol (VRRP) between edge network nodes that are acting as L3 router gateways on a service

The present technology is applicable for various layer 2 (L2) service types, for example shortest path bridging-MACinMAC (SPB-M), virtual extensible LAN (VxLAN), virtual private LAN services (VPLS), and the like. Several of the following examples will be presented with reference SPB-M; this choice is made to simplify the illustration of the presented embodiments and is not meant to limit the present disclosure. The shorter term “SPB” will be used in the following description for simplicity; it will however be understood that all variants of SPB and encompassed by the following examples.

In particular, the illustrative embodiments support both IP version 4 (IPv4) and IP version 6 (IPv6). Either of VPN-Lite and IP-VPN may be used to exchange customer routes across the SPB network. VPN-Lite allows exchanging customer routes across the SPB network. With VPN-Lite, routing protocols may run on L3 VPN IP interfaces or, alternatively, static routes maybe set up on L3 VPN interfaces. Under IP-VPN, exchange of routes method is different for different service types.

An IETF draft entitled “IP/IPVPN services with IEEE 802.1aq SPB networks” proposes a way to exchange layer 3 routes and forwarding IPv4/IPv6 unicast traffic over an SPB network. To exchange routes between VRFs over a SPB network, the IETF drafts proposes a new IP-VPN type length value (TLV) and sub-TLVs to carry IPv4/IPv6 routes.

Other mechanisms are used for services other than SPB. For example, internal border gateway protocol (iBGP) may be used to exchange routes for VPLS.

With these fundamentals in place, we will now consider some non-limiting examples to illustrate various implementations of aspects of the present technology.

### General L3 VPN Definition

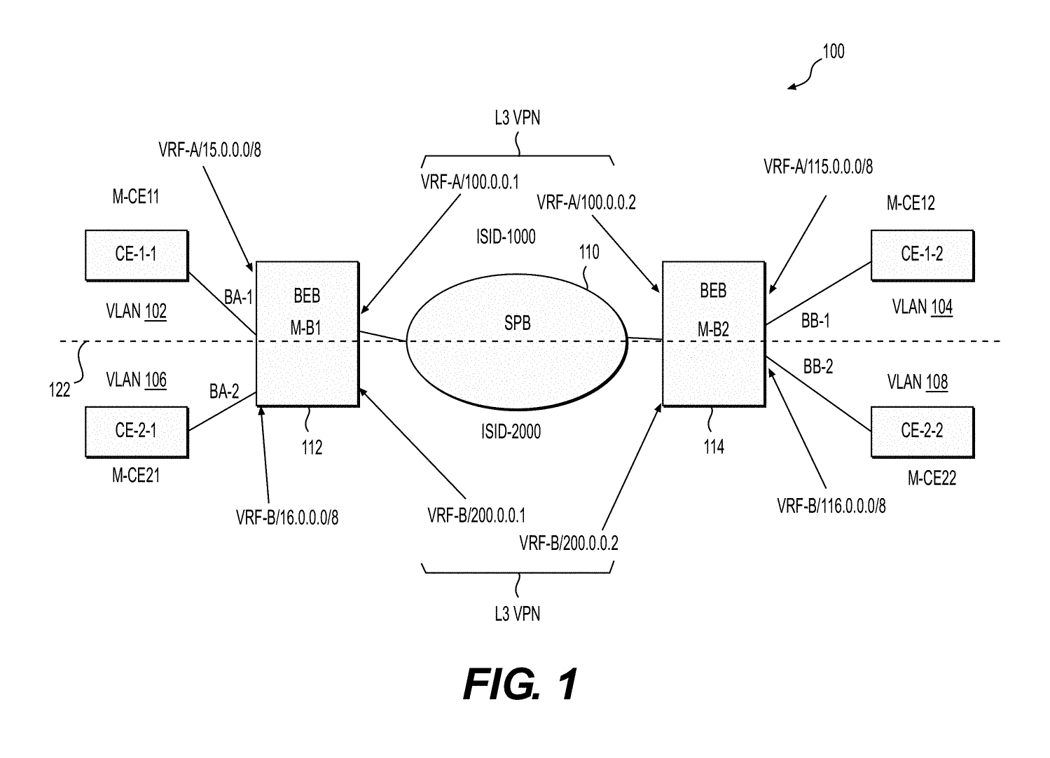

Referring to FIG. 1, there is shown a diagram of a network suitable for implementing the present technology and/or being used in conjunction with implementations of the present technology. Generally stated, a network 100 comprises a layer 2 (L2) backbone network and edge network nodes. Definition of layer 3 (L3) virtual private networks (VPN) in the network 100 allow endpoint terminals to interconnect via tunnels established between the edge network nodes. The endpoint terminals are customer equipment (CE) devices labelled CE-1-1, CE-1-2, CE-2-1 and CE-2-2, respectively having media access control (MAC) addresses M-CE11, M-CE12, M-CE21 and M-CE22. CE-1-1 and CE-1-2 are assigned to, and operated by, a first customer of the provider of the L2 backbone network, and are distributed over two (2) first sites. CE-2-1 and CE-2-2 are assigned to, and operated by, a second customer and are distributed over two (2) second sites. CE-1-1 and CE-2-1 may be located in distinct sites but they are both communicatively connected to a same edge network node.

CE-1-1 is part of a virtual local area network (VLAN) 102 of the first customer, CE-1-2 is part of a VLAN 104 of the first customer, CE-2-1 is part of a VLAN 106 of the second customer and CE-2-2 is part of a VLAN 108 of the second customer.

Without loss of generality, FIG. 1 shows a particular realization of the L2 backbone network implemented as a shortest path bridging (SPB) network 110 supporting the IEEE 802.1aq specification. Backbone Edge Bridges (BEB) 112 and 114 are edge network nodes that allow connecting the various endpoint terminals through the SPB network 110. Each of the BEBs 112 and 114 and other edge network nodes include the following elements:
at least one local port configured for exchanging packets with CE devices;
at least one network port configured for sending packets over one or more layer 2 backbone networks;
a memory device configured to store service information and routing information; and
a processor operatively connected with the local port and with the network port, the processor being operative to read and write into the memory device.

The following lines will describe service information and routing information that may be stored by the processor in the memory device of the BEBs 112 and 114 and other edge network nodes.

On FIG. 1, a dotted line 122 schematically shows how the network 100 provides two (2) distinct services, these distinct services being provided to the two (2) customers in the context of FIG. 1. The CEs are communicatively connected to the BEB 112 and 114 as follows: CE-1-1 is connected to the BEB 112 via a VLAN port BA-1, CE-2-1 is connected to the BEB 112 via a VLAN port BA-2, CE-1-2 is connected to the BEB 114 via a VLAN port BB-1 and CE-2-2 is connected to the BEB 114 via a VLAN port BB-2. Intermediate nodes, such as routers, gateways, relays and bridges may be present between the CEs and the BEBs; these are not shown in order to simplify the illustration.

In the context of FIG. 1, both BEBs 112 and 114 act has peer edge network nodes to one another. The BEB 112 and the BEB 114 have similar capabilities and the following description of the features of the BEB 112 equally applies to the BEB 114.

On FIG. 1, a separate broadcast domain is defined for each of the two (2) services. To this end, the BEBs 112 and 114 create IP interface relating the customers, the services and related IP addresses. In more details, the BEB 112 stores a definition of a first virtualized routing and forwarding (VRF) instance, hereinafter VRF-A, defined for the VLAN 102 of first customer. The BEB 112 also stores a first service identifier. In the context of SPB, the service identifier is an instance identifier (ISID), hereinafter ISID-1000, defined for the first customer. The BEB 112 associates the VRF-A and the ISID-1000 with a first routing table entry to create an IP interface for the ISID-1000. The first routing table entry comprises a first gateway address of the BEB 114 and a first set of L3 destination addresses (DA) of distant nodes reachable via the BEB 114. In the context of FIG. 1, the first gateway address of the BEB 114 is an internet protocol (IP) address 100.0.0.2 for the service identified as ISID-1000 and a range of IP addresses, or IP subnet, 115.0.0.0/8 contains available L3 DAs for reaching the CE-1-2 and for reaching eventual other CEs of the first customer located in the VLAN 104. Though in the present example the first set of L3 DAs comprises an IP subnet 115.0.0.0/8, another example may comprise a number of discrete IP addresses, for example 115.0.1.1, 115.0.1.2 and 115.0.1.3, or a plurality of IP subnets, for example 115.0.0.0/8 and 115.0.3.0/8. The present disclosure therefore does not limit any set of L3 DAs to any single IP subnet.

For the VLAN 106 of the second customer, the BEB 112 stores a definition of another VRF instance, hereinafter VRF-B. The BEB 112 also stores a second service identifier, hereinafter ISID-2000 defined for the second customer. The BEB 112 associates the VRF-B and the ISID-2000 with a second routing table entry comprising a second gateway address of the BEB 114 and a second set of L3 DAs of distant nodes reachable via the BEB 114. In the context of FIG. 1, the second gateway address of the BEB 114 is an IP address 200.0.0.2 for the service identified as ISID-2000 and a range of IP addresses 116.0.0.0/8 contains available L3 DAs for reaching the CE-2-2 and for reaching eventual other CEs of the second customer located in the VLAN 108.

In turn, the BEB 114 also stores the VRF-A, defined for the VLAN 104 of first customer, as well as the ISID-1000. The BEB 114 associates the VRF-A and the ISID-1000 with another routing table entry comprising a first gateway address of the BEB 112 and a first set of L3 DAs of distant nodes reachable via the BEB 112. In the context of FIG. 1, the first gateway address of the BEB 112 is an IP address 100.0.0.1 for the service identified as ISID-1000 and a range of IP addresses 15.0.0.0/8 contains available L3 DAs for reaching the CE-1-1 and for reaching eventual other CEs of the first customer located in the VLAN 102.

For the second customer, the BEB 114 stores the VRF-B, defined for the VLAN 108 of second customer, as well as and the ISID-2000. The BEB 114 associates the VRF-B and the ISID-2000 with yet another routing table entry comprising a second gateway address of the BEB 112 and a second set of L3 DAs of distant nodes reachable via the BEB 112. In the context of FIG. 1, the second gateway address of the BEB 112 is an IP address 200.0.0.1 for the service identified as ISID-2000 and a range of IP addresses 16.0.0.0/8 contains available L3 DAs for reaching the CE-2-1 and for reaching eventual other CEs of the second customer located in the VLAN 106.

The routing information contained in the routing table entries may be obtained using IP-VPN, VPN-Lite, or similar technologies. In the case of VPN-lite, OSPF, RIP, BGP or other routing protocols may be used. Static route configuration may also be used. In the case of IP-VPN, for SPB services, the routes may be exchanged by adding IP-VPN TLVs and sub-TLVs in the network topology advertisements.

Still referring to FIG. 1, packets are exchanged across the SPB network 110 from a given CE of a given customer to another CE of the same customer, as follows. Without loss of generality, the following example illustrates how a packet originated at the CE-2-1 is routed toward the CE-2-2.

The BEB 112 acquires a L2 address corresponding to the second gateway address 200.0.0.2 of the BEB 114. This L2 address is a system MAC address for the BEB 112 and it shown as M-B2 on FIG. 1. This operation can take place during initial configuration of the BEB 112 or at any time thereafter, up to and including after having received an outgoing packet from the CE-2-1. As an illustrative example, the L2 address of the BEB 114 may be a MAC address of the BEB 114 and may be obtained by the BEB 112 using the address resolution protocol (ARP).

The BEB 112 receives an outgoing packet from the CE-2-1 at its VLAN port BA-2. The outgoing packet comprises a header having:
A L2 source address (SA) (M-CE21) designating the CE-2-1,
A L3 SA designating the CE-2-1, for example 16.0.0.5,
A L2 DA M-B1 designating the BEB 112,
A L3 DA designating the CE-2-2, for example 116.0.0.7, and
A time to live (TTL) counter for the outgoing packet.

The skilled reader will appreciate that the CE-2-1 has an internal routing table associating the L3 DA for the outgoing packet, which is 116.0.0.7, to the second gateway address of the BEB 112, which is 200.0.0.1. The CE-2-1 has obtained the L2 DA M-B1 designating the BEB 112 based on this gateway address of the BEB 112, for example using ARP.

Because the L2 DA designates its own MAC address, the BEB 112 performs a route lookup as follows. The outgoing packet is received from a CE located in the VLAN 106 and, consequently, the BEB 112 associates the outgoing packet with the VRF-B. The BEB 112 also associates the outgoing packet with the ISID-2000 by mapping the L3 DA (116.0.0.7) to the range 116.0.0.0/8. In this and later defined use cases, the BEB 112 drops the outgoing packet if the L3 DA fails to map on any routing table entry. The BEB 112 may decrement the TTL counter. The BEB 112 encapsulates the outgoing packet in an outgoing tunnel packet by adding an outer header to the outgoing packet. In the case of SPB technology, the outgoing packet may be encapsulated by adding a provider backbone bridge (PBB) outer header. The outer header comprises the ISID-2000, and further comprises the M-B2 address of the BEB 114 as a L2 DA. Given that the service identifier is the ISID-2000, the BEB 112 forwards the outgoing tunnel packet over the SPB network 110.

The SPB network 110 forwards the tunnel packet according to its L2 DA, which is M-B2, so that the tunnel packet reaches the BEB 114. This packet is an incoming packet from the standpoint of the BEB 114. A tunnel termination interface (TTI) of the BEB 114 notes that the outer header comprises the ISID-200. The TTI determines, based on the ISID-2000, that the incoming packet relates to the VRF-B, and then removes the outer header. In the present example, the L3 DA is 116.0.0.7, which is in the range 116.0.0.0/8 for the VLAN 108. The BEB 114 performs a route lookup in a routing table for the VRF-B, based on the L3 DA, to find a next hop toward the CE-2-2. The BEB 114 then overwrites the L2 SA of the header with its own MAC address M-B2 and overwrites the L2 DA of the header with the MAC address M-CE22 of the CE-2-2. The BEB 114 may decrement the TTL counter. The BEB 114 then forwards the incoming packet toward the CE-2-2. The source and destination L3 addresses have not been modified and still respectively designate the CE-2-1 and the CE-2-2.

In a different use case, the CE devices may be connected via virtual tunnel end points (VTEP) and via a layer 3 backbone network, for example a virtual extensible local area network (VxLAN), as shown on a later drawing. In such embodiments, a first VTEP having received an outgoing packet from a CE device may omit the acquisition of a L2 address for a peer VTEP. The first VTEP encapsulates the outgoing packet in an outgoing tunnel packet by adding an outer header to the outgoing packet. In this case, the outer header comprises an appropriate service identifier for transport over the VxLAN, and further comprises a gateway address of the peer VTEP.

### Data Forwarding in the Edge Network Node

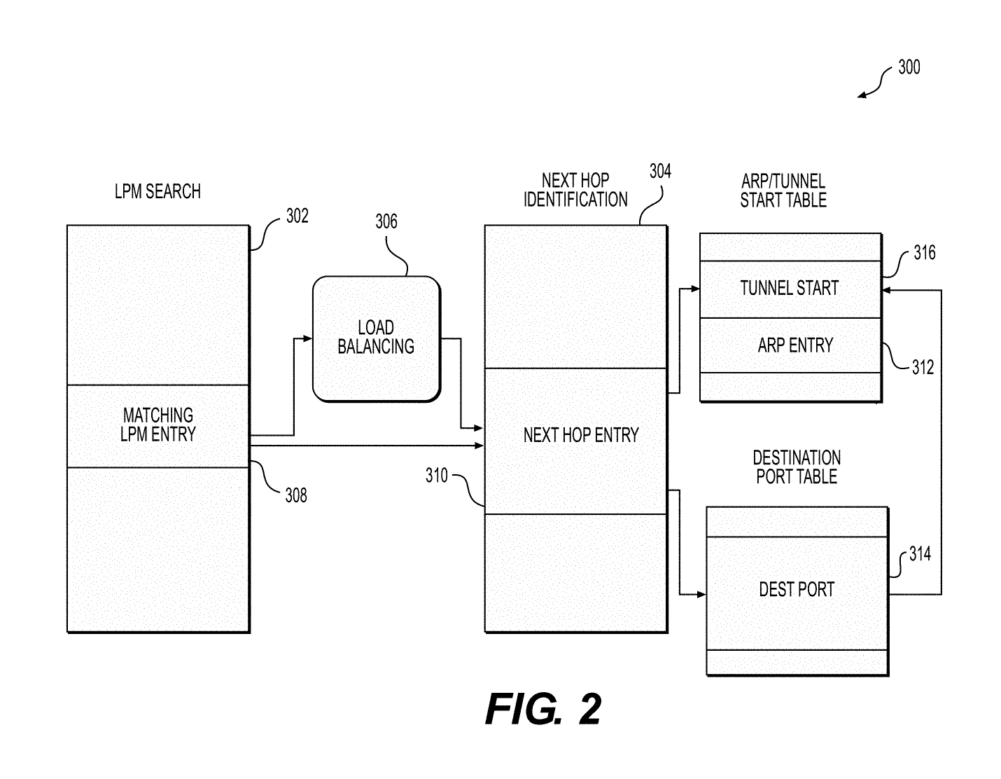

FIG. 2 is an internal block diagram of a routing decision process within an edge network node. A routing decision process 300 is performed in similar or equivalent operations in the edge network node, whether the edge network node is for example a BEB supporting shortest path bridging (SPB) technology or a virtual tunnel end point (VTEP) supporting virtual extensible local area network (VxLAN) technology. The routing decision process 300 is independent from the underlying L2 protocol of the backbone network. Generally speaking the routing decision process 300 includes a longest prefix match (LPM) search 302, a next hop identification 304, and may further comprise a load balancing operation 306.

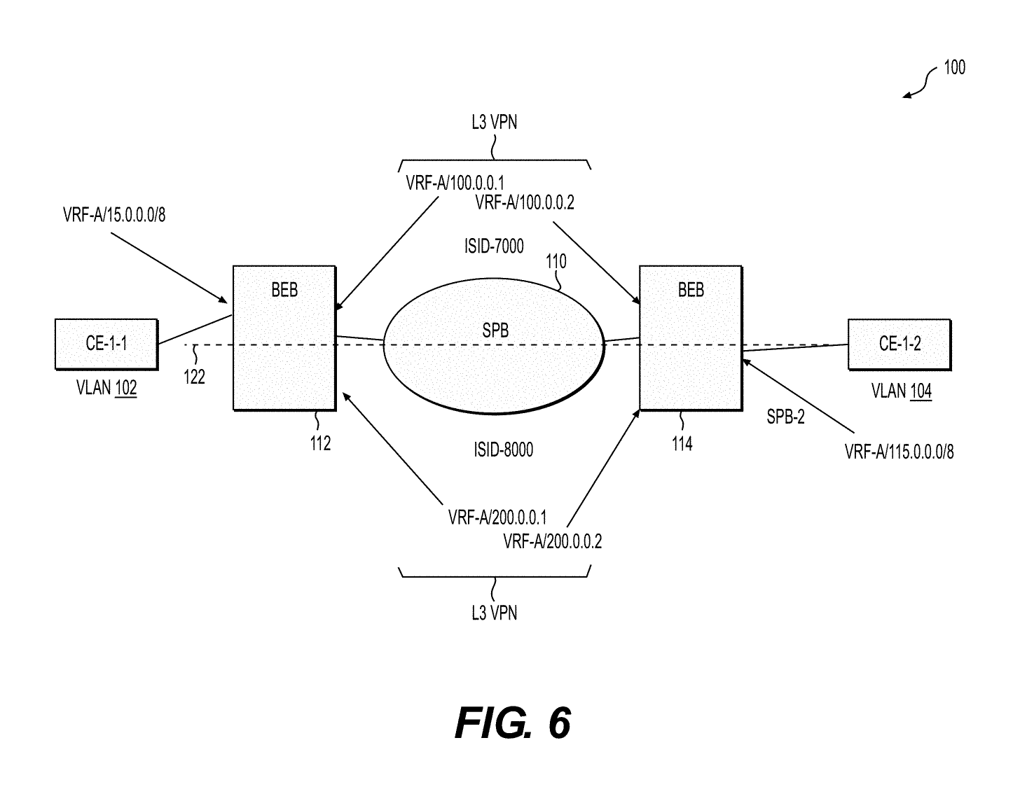

A routing table of the edge network node includes a plurality of routing table entries such as those mentioned in the foregoing description of FIG. 1. When the edge network node receives an outgoing packet from a CE, the edge network node first associates the outgoing packet with a relevant VRF, for example based on the VLAN of the CE. The LPM search 302 then looks for a match between a L3 DA present in a header of this packet and sets of L3 DAs of the routing table entries for the relevant VRF. This process allows the edge network node to associate the outgoing packet with the relevant service identifier. A matching LPM entry 308 may be used directly to determine a route for forwarding the packet. However, there may be more than one matching LPM entries 308 related to two (2) or more routing table entries having two (2) or more gateway addresses of peer edge network nodes for the same range of destination addresses. This may for example be the case when equal cost multipath (ECMP) technology is implemented in the edge network node; an example realization of these multiple routing table entries in a BEB will be described in the following description of FIG. 6. If the matching LPM entry 308 maps on more than one routing table entry, the load balancing operation 306 uses ECMP (or another similar protocol) to determine which of the gateway addresses will be used to direct the packet.

The next hop identification 304 relates the matching LPM entry 308 (or the entry selected by the load balancing operation 306) to a next hop entry 310 found in a next hop table. Generally, the next hop is a peer edge network node reachable via a tunnel through the L2 backbone network for reaching the L3 DA present in a header of this packet. The next hop entry 310 relates the gateway address of the next hop to an address resolution protocol (ARP) pointer 312, to a tunnel start field 316, and to a destination port 314. A L2 address of the next hop may be resolved, if not already known, from the ARP pointer 312. The destination port 314 is a virtual port (VP) on which ARP is resolved. The tunnel start field 316 contains details about a tunnel on which the outgoing packet is to be forwarded. The tunnel start field 316 defines a type of the tunnel, a tunnel identifier, a source address of the tunnel, a destination address of the tunnel, and similar information elements. These information elements are inserted in the outer header added to the outgoing packet by the edge network node.

### Service Architecture

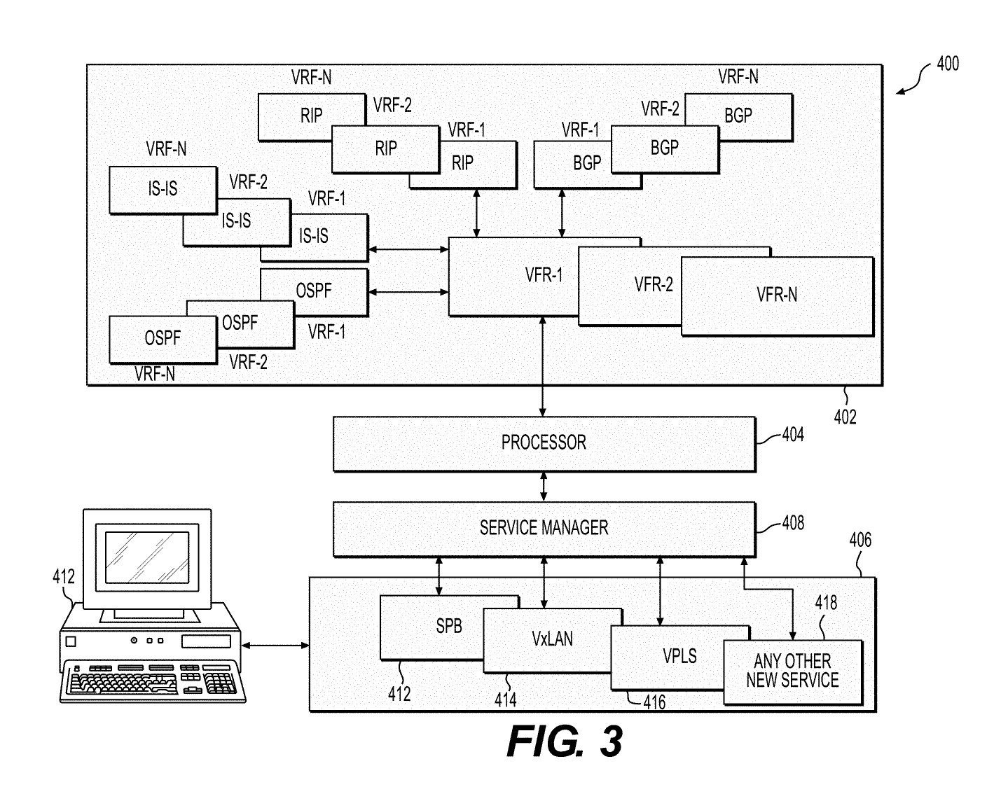

FIG. 3 is an illustration of a service architecture implemented in an edge network node. An edge network node 400 comprises a memory device 402 and a processor 404 as expressed hereinabove. The edge network node further comprises a service provisioning interface 406, a service manager 408, and an operator interface 410. The service provisioning interface 406 may be used to define layer 2 transport services such as SPB 412, VxLAN 414, Virtual Private LAN Services (VPLS) 416 and any other service 418. Using the operator interface 410, an operator of the edge network node 400 may define, activate, deactivate, modify or delete various information elements related to the services 412, 414, 416 and 418. The service manager 408 generally manages all services supported by the edge network node 400, manages the L3 VPN interfaces created for the services, and maintains separate broadcast domains for these services. It creates and manages virtual ports (VP) for local ports used to exchange packets with the CE devices and for network ports leading to the L2 backbone network. The service manager 408 receives and parses service information from the service provisioning interface 406 and sends the service information to the processor 404. The service manager 408 may inform the processor 404 of service activation and of service deactivation, of VP creation or deletion, and the like. The service manager 408 may delete any part of the service information and to inform the processor 404 of the deletion.

The processor 404 stores, updates or deletes information about the various services in the memory device 402. For each of various VRFs such as VRF-1, VRF-2 up to VRF-N, information elements stored in the memory device 402 includes, without limitation, configuration information for a routing protocol, for example an open shortest path first (OSPF), a routing information protocol (RIP), a border gateway protocol (BGP), or an intermediate system to intermediate system (IS-IS) protocol.

### Router Gateway

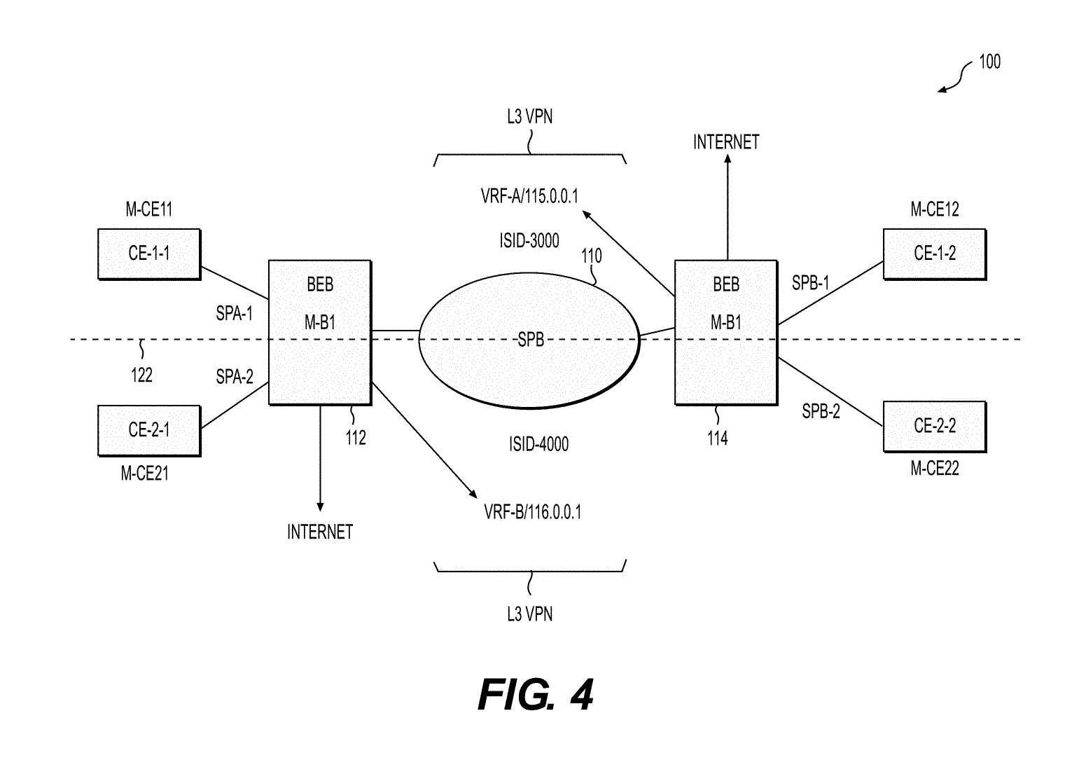

FIG. 4 is a diagram showing an application of the network of FIG. 1 for provision of a router gateway. This topology may be used, for example, as a firewall so that all CE devices of a customer may only exchange packets with the Internet through a single access point, for security reasons. Without loss of generality and for ease of illustration, the network 100 contains the same elements as those introduced in the foregoing description of FIG. 1, each of those elements having the same MAC addresses except where otherwise noted. The CE devices may be connected to service access ports denoted SPA-1, SPA-2, SPB-1 and SPB-2. In the non-limiting example of FIG. 4, the BEBs 112 and 114 are still configured with VRF-A and VRF-B for the same two (2) customers. Two (2) new services are defined to allow both BEBs 112 and 114 to act as router gateways for Internet access. In the non-limiting embodiment of FIG. 4, the L2 backbone network is still implemented as the SPB network 110 so the two (2) new services are defined as instance identifiers, that is, ISID-3000 and ISID-4000.

An Internet access service is defined for the first customer by associating the VRF-A with the service identifier ISID-3000. CE devices of the first customer may only access the Internet through the BEB 114, which is the single access point for the first customer, at a gateway address 115.0.0.1. Likewise, an Internet access service is defined for the second customer by associating the VRF-B with the service identifier ISID-4000. CE devices of the second customer may only access the Internet through the BEB 112, which is the single access point for the second customer, at a gateway address 116.0.0.1. These gateway addresses of the BEBs 112 and 114 are exposed to the CE devices, which can use them to direct outgoing packets for any destination IP address.

The BEB 112 does not define any routing table for the first customer, i.e. for the VRF-A and for the ISID-3000 because the BEB 112 is not the single access point for the first customer. The BEB 112 however stores an association of the ISID-3000 with the service access port SPA-1. For the second customer, the BEB 112 associates the VRF-B and the ISID-4000 with the service access port SPA-2 and with one or more routing table entries that associate a gateway address supplied by an Internet service provider (ISP), for example 223.0.0.1 (not shown), with one or more ranges of IP addresses, or IP subnets, for example 103.0.0.0/8, which are addresses of routers for accessing the Internet.

The BEB 114 stores the VRF-A in connection with the service identifier ISID-3000 for the first customer. The BEB 114 associates the VRF-A and the ISID-3000 with the service access port SPB-1 and with one or more routing table entries that associate a gateway address supplied by an ISP, for example 123.0.0.2 (not shown), with one or more ranges of IP addresses, or IP subnets, for example 201.0.0.0/8. The BEB 114 does not define any routing table for the second customer because the BEB 114 is not the single access point for the second customer. The BEB 114 stores an association of the ISID-4000 with the service access port SPB-2. It is noted that the ISP that provides the gateway address 223.0.0.1 to the BEB 112 may or may not be the same as the ISP that provides the gateway address 123.0.0.2 to the BEB 114.

Still referring to FIG. 4, the various CEs may attempt to access an Internet resource. The following two (2) examples illustrate how, in an embodiment, the BEB 112 forwards an outgoing packet from the CEs connected thereto.

In a first example, the BEB 112 receives an outgoing packet from the CE-1-1 at its service access port SPA-1. The outgoing packet comprises a header having:

A L2 SA (M-CE11) designating the CE-1-1,

A L3 SA designating the CE-1-1,

A L2 DA M-B2 designating the BEB 114,

A L3 DA designating an Internet resource, for example 201.0.0.1, and

A TTL counter for the outgoing packet.

The skilled reader will appreciate that the CE-1-1 has an internal routing table associating the L3 DA for the outgoing packet, which is 201.0.0.1, to a gateway address of the BEB 114, shown as 115.0.0.1 on FIG. 4. The CE-1-1 has obtained the L2 DA M-B2 designating the BEB 114 based on this gateway address of the BEB 114, for example using ARP. The outgoing packet is received at the BEB 112 because the CE-1-1 is connected to the SPA-1.

Because the L2 DA does not designate its own MAC address, the BEB 112 does not perform any route lookup. Instead, it switches the outgoing packet based on the L2 DA. Because the outgoing packet is received at the service access port SPA-1, the BEB 112 associates the outgoing packet with the ISID-3000. The BEB 112 encapsulates the outgoing packet in an outgoing tunnel packet by adding an outer header to the outgoing packet. The outer header comprises the same L2 address of the BEB 114 that was received as a L2 DA in the outgoing packet. The outer header also comprises the ISID-3000.

Given that the BEB 114 is reachable via the SPB network 110, the BEB 112 forwards the outgoing tunnel packet over the SPB network 110. The SPB network 110 forwards the tunnel packet according to its L2 DA so that the tunnel packet reaches the BEB 114.

Having received the tunnel packet, now an incoming packet, the BEB 114 decapsulates the incoming packet by removing the outer header. The BEB 114 detects that the L2 DA designates its own MAC address. Consequently, the BEB 114 performs a route lookup. The BEB 114 verifies that the L3 DA (201.0.0.1) validly maps to the one or more ranges of IP addresses, or IP subnets, for the ISID-3000, which is 201.0.0.0/8 in the present example. As long as the L3 DA is valid, the BEB 114 overwrites the L2 SA of the header with its own MAC address and overwrites the L2 DA with a MAC address corresponding to the gateway address provided by the ISP, which is 123.0.0.2 in the present example. The BEB 114 may decrement the TTL counter. The BEB 114 then routes the incoming packet toward the Internet resource based on the L3 DA present in the header of the incoming packet. The BEB 114 drops the outgoing packet if its L3 DA is invalid.

In a different use case, the CE devices may be connected via VTEPs and via a layer 3 backbone network, for example a VxLAN. In such embodiments, the outer header comprises an appropriate service identifier for transport over the VxLAN, and further comprises the same L3 DA that was received in the outgoing packet.

With continuing reference to FIG. 4, in a second example, the BEB 112 receives an outgoing packet from the CE-2-1 at its service access port SPA-2. The outgoing packet comprises a header having:
A L2 SA (M-CE21) designating the CE-2-1,
A L3 SA designating the CE-2-1, for example 16.0.0.5,
A L2 DA M-B1 designating the BEB 112,
A L3 DA designating an Internet resource, for example 103.0.0.1, and
A TTL counter for the outgoing packet.

The skilled reader will appreciate that the CE-2-1 has an internal routing table associating the L3 DA for the outgoing packet, which is 103.0.0.1, to a gateway address of the BEB 112, shown as 116.0.0.1 on FIG. 4. The CE-2-1 has obtained the L2 DA M-B1 designating the BEB 112 based on this gateway address of the BEB 114, for example using ARP

Because the L2 DA designates its own MAC address, the BEB 112 performs a route lookup as follows. The outgoing packet is received at the service access port SPA-2 and, consequently, the BEB 112 associates the outgoing packet with the ISID-4000 and with the VRF-B. The BEB 112 verifies that the L3 DA (103.0.0.1) validly maps to the one or more ranges of IP addresses, or IP subnets for the ISID-4000, 103.0.0.0/8. in the present example. As long as the L3 DA is valid, the BEB 112 overwrites the L2 SA of the header with its own MAC address and overwrites the L2 DA with a MAC address corresponding to the gateway address provided by the ISP, which is 223.0.0.1 in the present example. The BEB 112 may decrement the TTL counter. The BEB 112 then routes the outgoing packet toward the Internet resource based on the L3 DA present in the header of the outgoing packet. The BEB 112 drops the outgoing packet if its L3 DA is invalid.

### Virtual Router Redundancy Protocol

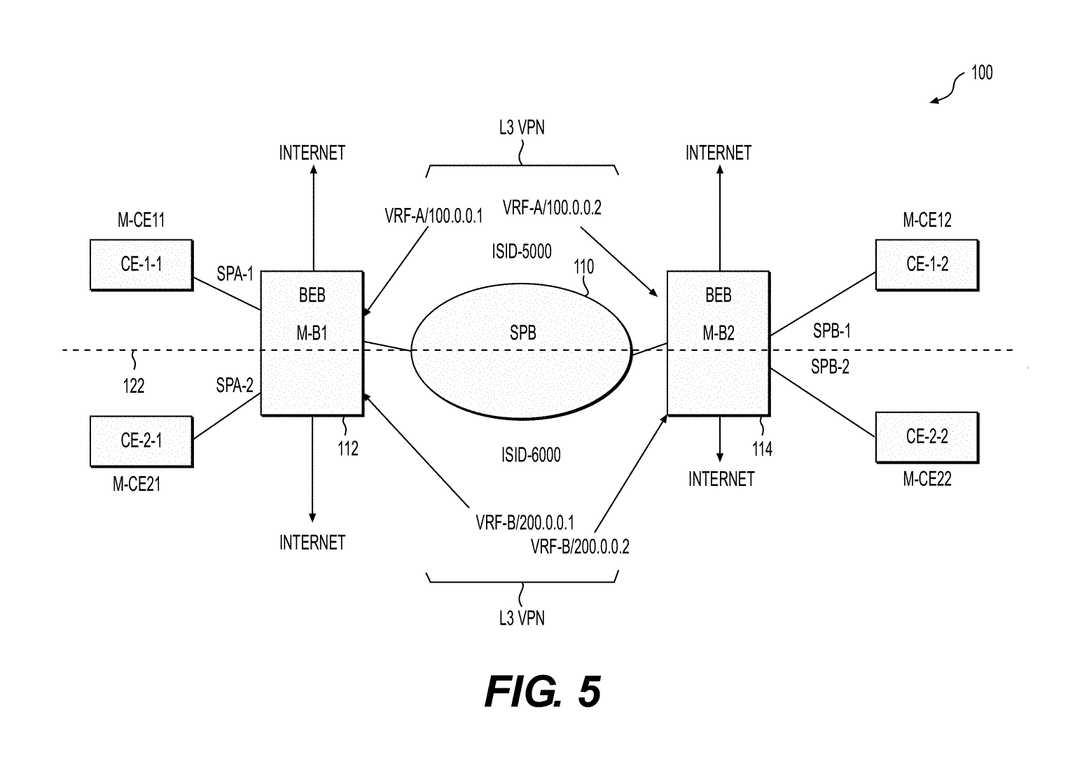

FIG. 5 is a diagram showing an application of the network of FIG. 1 for provision of a Virtual Router Redundancy Protocol (VRRP). In comparison with FIG. 4, this topology provides that the BEBs 112 and 114 become redundant Internet access points for both customers. For a given service, one access point may have a higher priority than the other access point, becoming a master access point for that service. Determination of the master may be based, for example on connectivity, bandwidth or other considerations. Without limitation, the BEBs 112 and 114 may allow a given customer to connect to distinct Internet service providers. Without loss of generality and for ease of illustration, the network 100 contains the same elements as those introduced in the foregoing description of FIG. 1, each of those elements having the same MAC addresses except where otherwise noted. The CE devices may be connected to service access ports denoted SPA-1, SPA-2, SPB-1 and SPB-2. In the non-limiting example of FIG. 5, the BEBs 112 and 114 are still configured with VRF-A and VRF-B for the same two (2) customers.

As in the case of FIG. 4, two (2) new services are defined to allow both BEBs 112 and 114 to act as router gateways for Internet access. In the non-limiting embodiment of FIG. 5, the L2 backbone network is still implemented as the SPB network 110 so the two (2) new services are defined as instance identifiers, that is, ISID-5000 and ISID-6000. In contrast with the Router Gateway scenario of FIG. 4, gateway addresses of the BEBs 112 and 114 as shown on FIG. 5 are not exposed to the CE devices. Instead, virtual IP addresses, which are described hereinbelow, are exposed to the CE devices.

In more details, for the first customer, the BEB 112 associates the VRF-A, the service access port SPA-1 and the ISID-5000 with a first routing table entry that associates a first gateway address supplied by an ISP, for example 123.0.0.2, with one or more ranges of IP addresses, or IP subnets, which are addresses of routers for accessing the Internet, for example 207.0.0.0/8. For the second customer, the BEB 112 associates the VRF-B, the service access port SPA-2 and the ISID-6000 with a second routing table entry that associates a second gateway address supplied by an ISP, for example 223.0.0.2, with one or more ranges of IP addresses, or IP subnets, for example 212.0.0.0/8.

The BEB 114 associates the VRF-A, the service access port SPB-1 and the ISID-5000 with a third routing table entry that associates a third gateway address supplied by an ISP, for example 123.0.0.1, with the one or more ranges of IP addresses, or IP subnets, for example 207.0.0.0/8, that are also defined for the ISID-5000 in the BEB 112. The BEB 114 also associates the VRF-B, the service access port SPB-2 and the ISID-6000 with a fourth routing table entry that associates a fourth gateway address supplied by an ISP, for example 223.0.0.1, with the one or more ranges of IP addresses, or IP subnets, for example 212.0.0.0/8, that are also defined for the ISID-6000 in the BEB 112.

It may be noted that, in the above description of how the BEBs 112 and 114 define a total of four (4) routing table entries, the order of those definitions is not meant to designate any hierarchy between the routing table entries. It is noted that the various gateway addresses may be provided by the same or by various ISPs.

Virtual IP addresses that are exposed to the CE devices are assigned for each of the VRF/service association in the BEBs 112 and 114. A first virtual IP address for the VRF-A and for the ISID-5000 has, for example, a value of 100.0.0.3. A second virtual IP address for the VRF-B and for the ISID-6000 has, for example, a value of 200.0.0.3. At any given time, one of the BEBs 112 and 114 owns the virtual IP address for a service and is therefore the master access point for that service.

In an embodiment, which one of the BEB 112 or 114 is the master for each service may, at least initially, be configured by an operator of the network 100. In the same or in another embodiment, the BEBs 112 and 114 may exchange control frames over the SPB network 110 to provide each other with information about their current state (available or unavailable), their current loading level and/or available bandwidth. Still in the same or other embodiments, each BEB may periodically forward so-called heartbeat signals over the SPB network 110 and a given BEB may assume the master function for a service when a peer BEB has failed to timely provide the heartbeat signal.

Accordingly, the BEBs 112 and 114 may determine which BEB becomes a master for a given service or for all services. VRRP operation is independent in various services; as such, one of the BEBs 112 and 114 may become a master for the ISID-5000 while the other becomes a master for the ISID-6000. Alternatively, one of the BEBs 112 and 114 may be the master for both services. The BEB 112 may for example receive an indication that the BEB 114 is not available. In that case, the BEB 112 may become the master for all services so that, as a result, the BEB 112 can autonomously direct outgoing packets from the CE-1-1 or from the CE-2-1 toward Internet resources.

The master for a given service creates a virtual MAC (VMAC) address corresponding to the virtual IP address for that service. In the present example and for illustration purposes, V-100 is the VMAC address for the virtual IP address 100.0.0.3 and V-200 is the VMAC address for the virtual IP address 200.0.0.3.

The following two (2) examples may occur regardless of the circumstances that caused one of the BEBs 112 and 114 to be configured as the master for a given service and thereby own the virtual IP address and the VMAC for that service. Initially, the BEB 112 receives an outgoing packet, for example from the CE-1-1, at its service access port SPA-1. The outgoing packet comprises a header having:
A L2 SA (M-CE11) designating the CE-1-1,
A L3 SA designating the CE-1-1, for example 15.0.0.5,
A L2 DA set to V-100;
A L3 DA designating an Internet resource, for example 207.0.0.5, and
A TTL counter for the outgoing packet.

In a first example, the BEB 112 is the master and owns the first virtual IP address as well as the VMAC.

As expressed hereinabove, the virtual IP addresses are exposed to the CE devices. The CE-1-1 has an internal routing table associating the L3 DA for the outgoing packet, which is 207.0.0.5, to the first virtual IP address, which is 100.0.0.3. Using ARP for example, the CE-1-1 has obtained the VMAC address V-100 for the first virtual IP address.

Considering that, in this first example, the BEB 112 owns the V-100 VMAC address, the BEB 112 performs a route lookup as follows. The outgoing packet is received at the service access port SPA-1 and, consequently, the BEB 112 associates the outgoing packet with the ISID-5000 and with the VRF-A. The BEB 112 verifies that the L3 DA (207.0.0.5) validly maps to the one or more ranges of IP addresses, or IP subnets for the ISID-5000, 207.0.0.0/8 in the present example. As long as the L3 DA is valid, the BEB 112 overwrites the L2 SA of the header with its own MAC address and overwrites the L2 DA with a MAC address corresponding to the gateway address provided by the ISP, which is 123.0.0.2 in the present example. The BEB 112 may decrement the TTL counter. The BEB 112 then routes the outgoing packet toward the Internet resource based on the L3 DA present in the header of the outgoing packet. The BEB 112 drops the outgoing packet if its L3 DA is invalid.

In a second example, the BEB 114 is the master and owns the first virtual IP address as well as the VMAC.

As in the previous example, the CE-1-1 has an internal routing table associating the L3 DA for the outgoing packet, which is 207.0.0.5, to the first virtual IP address, which is 100.0.0.3. Using ARP for example, the CE-1-1 has obtained the VMAC address V-100 for the first virtual IP address.

Though it has received the outgoing packet, the BEB 112 determines that it does not own the L2 DA, which is the VMAC. Consequently, the BEB 112 does not perform any route lookup. Instead, it switches the outgoing packet based on the L2 DA. Because the outgoing packet is received at the service access port SPA-1, the BEB 112 associates the outgoing packet with the ISID-5000. The BEB 112 encapsulates the outgoing packet in an outgoing tunnel packet by adding an outer header to the outgoing packet. The outer header comprises the V-100 VMAC address, currently owned by the BEB 114, as a L2 DA and the ISID-5000. Given that the BEB 114 is reachable via the SPB network 110, the BEB 112 forwards the outgoing tunnel packet over the SPB network 110. The SPB network 110 forwards the tunnel packet according to its L2 DA so that the tunnel packet reaches the BEB 114.

Having received the tunnel packet, now an incoming packet, the BEB 114 decapsulates the incoming packet by removing the outer header. The BEB 114 detects that the L2 DA designates the V-100 VMAC address that it currently owns. Consequently, the BEB 114 performs a route lookup. The BEB 114 verifies that the L3 DA (207.0.0.5) validly maps to the one or more ranges of IP addresses, or IP subnets, for the ISID-5000, which is 207.0.0.0/8 in the present example. As long as the L3 DA is valid, the BEB 114 overwrites the L2 SA of the header with its own MAC address and overwrites the L2 DA with a MAC address corresponding to the gateway address provided by the ISP, which is 123.0.0.1 in the present example. The BEB 114 may decrement the TTL counter. The BEB 114 then routes the incoming packet toward the Internet resource based on the L3 DA present in the header of the incoming packet. The BEB 114 drops the outgoing packet if its L3 DA is invalid. In a different use case, the CE devices may be connected via VTEPs and via a layer 3 backbone network, for example a VxLAN. In such embodiments, the outer header comprises an appropriate service identifier for transport over the VxLAN, and further comprises the same L3 DA that was received in the outgoing packet.

### Equal Cost Multi Path

FIG. 6 is a diagram showing an application of the network of FIG. 1 using a load balancing protocol. Without limitation, the configuration of the network 100 shown in FIG. 6 may use Equal Cost Multi Paths (ECMP) as the load balancing protocol. Without loss of generality and for ease of illustration, the network 100 contains several of the same elements as those introduced in the foregoing description of FIG. 1. Those elements that are common to FIGS. 1 and 6 have the same MAC addresses except where otherwise noted. The CE-1-1 is still part of the same VLAN 102 and the CE-1-2 is still part of the same VLAN 104. The BEBs 112 and 114 are configured with a single VRF, namely VRF-A, as only one (1) customer is shown. Two (2) new services are defined to allow both BEBs 112 and 114 to serve the customer using ECMP. In the non-limiting embodiment of FIG. 4, the L2 backbone network is still implemented as the SPB network 110 so the two (2) new services are defined as instance identifiers, that is, ISID-7000 and ISID-8000. As in earlier Figures, the dotted line 122 schematically separates the two (2) services. The CE-1-1 and the CE-1-2 both have access to the two (2) new services.

The BEB 112 associates the VRF-A and the ISID-7000 with a first routing table entry comprising a first gateway address of the BEB 114 and a set of L3 DAs of distant nodes reachable via the BEB 114. In the context of FIG. 1, the first gateway address of the BEB 114 is an IP address 100.0.0.2 for the service identified as ISID-7000 and a range of IP addresses 115.0.0.0/8 contains available L3 DAs for reaching the CE-1-2 and for reaching eventual other CEs of the first customer located in the VLAN 104. The BEB 112 also associates the VRF-A and the ISID-8000 with a second routing table entry comprising a second gateway address of the BEB 114 and the same set of L3 DAs of distant nodes reachable via the BEB 114. In the context of FIG. 6, the second gateway address of the BEB 114 is an IP address 200.0.0.2 for the service identified as ISID-8000.

The BEB 114 also stores the VRF-A in connection with the service identifier ISID-7000 with a first routing table entry comprising a first gateway address of the BEB 112 and a set of L3 DAs of distant nodes reachable via the BEB 112. In the context of FIG. 1, the first gateway address of the BEB 112 is an IP address 100.0.0.1 for the service identified as ISID-7000 and a range of IP addresses 15.0.0.0/8 contains available L3 DAs for reaching the CE-1-1 and for reaching eventual other CEs of the first customer located in the VLAN 102. The BEB 114 also associates the VRF-A and the ISID-8000 with a second routing table entry comprising a second gateway address of the BEB 112 and the same set of L3 DAs of distant nodes reachable via the BEB 112. In the context of FIG. 6, the second gateway address of the BEB 112 is an IP address 200.0.0.1 for the service identified as ISID-8000.

Of course, though FIG. 6 illustrates the configuration of two (2) services for the same customer using VRF-A, the BEBs 112 and 114 may also provide the same or additional services to this and other customers. Though not explicitly illustrated, the network 100 of FIG. 6 can integrate the CE-2-1 and the CE-2-2 introduced in the foregoing description of FIG. 1. In such case, additional service instances may be defined to provide services to those customer equipment devices.

As in the previous examples, the BEB 112 acquires a first L2 address corresponding to the first gateway address of the BEB 114, which is the IP address 100.0.0.2. The BEB 112 also acquires a second L2 address corresponding to the second gateway address of the BEB, which is the IP address 200.0.0.2. These operations may take place either before or after having received an outgoing packet from the CE-1-1.

The BEB 112 receives an outgoing packet from the CE-1-1 at its VLAN port BA-1. The outgoing packet comprises a header having:
A L2 SA (M-CE11) designating the CE-1-1,
A L3 SA designating the CE-1-1, for example 15.0.0.5,
A L2 DA M-B1 designating the BEB 112,
A L3 DA designating the CE-1-2, for example 115.0.0.7, and
A TTL counter for the outgoing packet.

Because the L2 DA designates its own MAC address, the BEB 112 performs a route lookup as follows. The outgoing packet is received from a CE located in the VLAN 102 and, consequently, the BEB 112 associates the outgoing packet with the VRF-A. The L3 DA (115.0.0.7) maps to the range 115.0.0.0/8 for the VLAN 104, which is consistent with either of ISID-700 and ISID-8000. Using a load balancing protocol, for example ECMP, the BEB 112 selects one of the services identified as ISID-7000 and ISID-8000; by this selection, the BEB 112 also selects one of the first and second gateway addresses of the BEB 114.

The BEB 112 may decrement the TTL counter. The BEB 112 encapsulates the outgoing packet in an outgoing tunnel packet by adding an outer header to the outgoing packet. The outer header comprises the selected one of the ISID-7000 and ISID-8000 along with the corresponding L2 DA of the BEB 114. Given that the service identifier is an ISID, the BEB 112 forwards the outgoing tunnel packet over the SPB network 110.

The SPB network 110 forwards the tunnel packet according to its L2 DA so that the now incoming tunnel packet reaches the BEB 114. The BEB 114 removes the outer header, having verified that the L3 DA is within the proper range for the ISID indicated in the outer header. In the present example, the L3 DA is 115.0.0.7, which is in the range 115.0.0.0/8 for the VLAN 104. Given that the L3 DA is within the proper range, the BEB 114 overwrites the L2 SA of the header with its own MAC address and overwrites the L2 DA of the header with the MAC address M-CE12 of the CE-1-2. The BEB 114 may decrement the TTL counter. The BEB 114 then forwards the incoming packet toward the CE-1-2. The source and destination L3 addresses have not been modified and still respectively designate the CE-1-1 and the CE-1-2.

In a different use case, the CE devices may be connected via VTEPs and via a layer 3 backbone network, for example a VxLAN. In yet another use case, the CE devices may be connected via dual-mode edge network nodes, for example BEB/VTEP, capable of serving the CE devices over either of a L2 SPB backbone network or over a L3 VxLAN backbone network. In such embodiments, the acquisition of a L2 address may be omitted or not, depending on the backbone network that will actually transport the outgoing packet The outer header comprises an appropriate service identifier for transport over the VxLAN or over the SPB and further comprises a L2 or L3 address of the peer edge network node.

### Multiple Tunnels

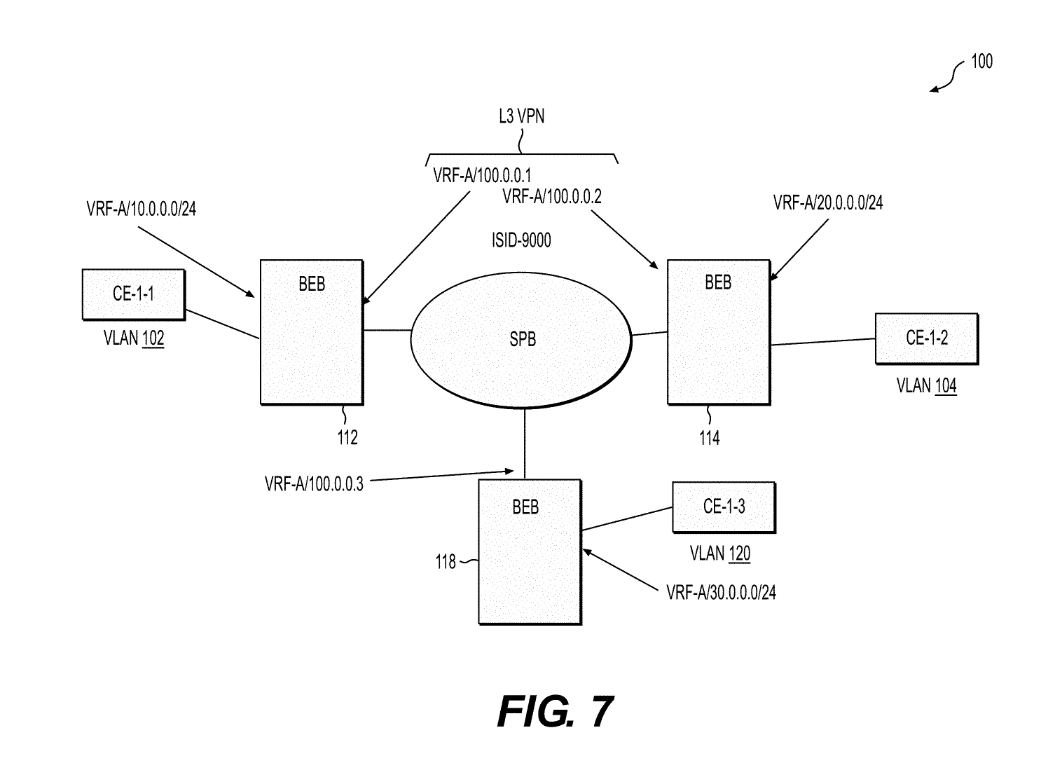

FIG. 7 is a diagram illustrating a creation of multiple tunnels. Another edge network node, named BEB 118, is added to the network 100. The BEB 118 is a peer to the BEBs 112 and 114 and has the same or equivalent features and capabilities as the BEBs 112 and 114. The BEB 118 serves a CE-1-3 for the same first customer that also owns the CE-1-1 and the CE-1-2. The CE-1-3 has a MAC address M-CE13 and is part of a VLAN 120 of the first customer. Tunnels may be created between any pair of the BEBs 112, 114 and 118.

The BEB 112 associates the VRF-A with an ISID-9000 defined for the first customer and with two (2) routing table entries for connecting the CE-1-1 with the CE-1-2 and with the CE-1-3, respectively. A first routing table entry comprises a first gateway address 100.0.0.2 of the BEB 114 and a first set of L3 DAs of distant nodes reachable via the BEB 114, the first set including a range of IP addresses 20.0.0.0/24, which are available L3 DAs for reaching the CE-1-2 and for reaching eventual other CEs of the first customer located in the VLAN 104. A second routing table entry comprises a second gateway address 100.0.0.3 of the BEB 118 and a second set of L3 DAs of distant nodes reachable via the BEB 118, the second set including a range of IP addresses 30.0.0.0/24, which are available L3 DAs for reaching the CE-1-3 and for reaching eventual other CEs of the first customer located in the VLAN 120. While the example of FIG. 1 shows an embodiment in which one VRF and one service identifier are associated with one (1) routing table entry, FIG. 7 show that the same VRF and service identifier may be associated with two (2) routing table entries. In other embodiments, a given VRF and a given service identifier may be associated with larger number of routing table entries so that multiple tunnels may be created across L2 backbone networks between larger numbers of edge network nodes. Of course, other customers may be served in the network 100 by defining additional VRFs and ISIDs.

The BEB 114 also stores the VRF-A and the ISID-9000 defined for the first customer and with two (2) routing table entries for connecting the CE-1-2 with the CE-1-1 and with the CE-1-3, respectively. A third routing table entry comprises a third gateway address 100.0.0.1 of the BEB 112 and a third set of L3 DAs of distant nodes reachable via the BEB 112, the third set including a range of IP addresses 10.0.0.0/24, which are available L3 DAs for reaching the CE-1-1 and for reaching eventual other CEs of the first customer located in the VLAN 102. A fourth routing table entry comprises the second gateway address 100.0.0.3 of the BEB 118 and the second set of L3 DAs of distant nodes reachable via the BEB 118.

The BEB 118 also stores the VRF-A and the ISID-9000 defined for the first customer and with two (2) routing table entries for connecting the CE-1-3 with the CE-1-1 and with the CE-1-2, respectively. A fifth routing table entry comprises the third gateway address 100.0.0.1 of the BEB 112 and the third set of L3 DAs of distant nodes reachable via the BEB 112. A sixth routing table entry comprises the first gateway address 100.0.0.2 of the BEB 114 and the first set of L3 DAs of distant nodes reachable via the BEB 114.

Still referring to FIG. 7, packets are exchanged across the SPB network 110 between any one of CE-1-1, CE-1-2 or CE-1-3 and any other one of these CEs. One of the CEs sends an outgoing packet to the BEB to which it is connected. The receiving BEB maps a L3 DA present in a header of an outgoing packet to one of the ranges of destination addresses of the routing table entries and thereby to the VRF-A and to the ISID-9000. The outgoing packet is encapsulated by adding an outer header to an outgoing tunnel packet and forwarded on the SPB network 110 in the manner described hereinabove. The outer header includes a L2 address of the BEB corresponding to the L3 DA.

In a different use case, the CE devices may be connected via VTEPs and via a layer 3 backbone network, for example a VxLAN. In such embodiments, a first VTEP having received an outgoing packet from a CE device may omit the acquisition of a L2 address for a peer VTEP. The first VTEP encapsulates the outgoing packet in an outgoing tunnel packet by adding an outer header to the outgoing packet. The outer header comprises an appropriate service identifier for transport over the VxLAN, and further comprises a gateway address of the peer VTEP.

### Routing Between Different Types of Services

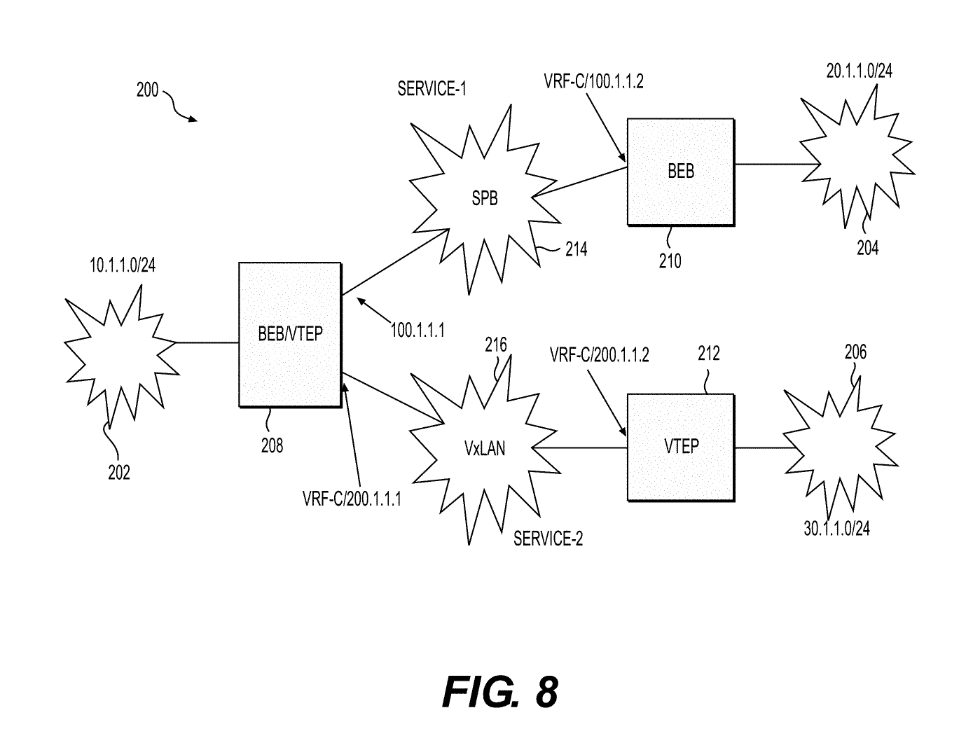

FIG. 8 is a diagram illustrating routing between different service types. In the illustrative example of FIG. 8, a network 200 connects three (3) sites 202, 204 and 206 operated by a customer identified with a virtualized routing and forwarding instance VRF-C. Three (3) edge network nodes are shown. A first edge network node combines the capabilities of a BEB with those of a virtual tunnel end point (VTEP) and is referred herein as a BEB/VTEP 208. A second edge network node is a BEB 210. A third edge network node is a VTEP 212. The BEB/VTEP 208 and the BEB 210 are both connected to a SPB network 214. The BEB/VTEP 208 and the VTEP 212 are both connected to a Virtual Extensible LAN (VxLAN) 216. Although no direct connection is provided between the BEB 210 and the VTEP 212 in the example of FIG. 8, such connection may be established by providing a compatible L2 backbone network between these edge network nodes.

The network 200 provides two (2) distinct services for a same customer. One service is labelled Service-1 and provides packet transport over the SPB network 214 between the sites 202 and 204. It is in fact an instance identifier (ISID) and is shown as “Service-1” for clarity. Another service, labelled Service-2, provides packet transport over the VxLAN 216.

The BEB/VTEP 208 stores a VRF-C defined for a customer having the sites 202, 204 and 206. The BEB/VTEP 208 also stores the service identifiers Service-1 and Service-2. The BEB/VTEP 208 associates the VRF-C and the Service-1 with a first routing table entry comprising a first gateway address of the BEB 210 and a first set of L3 DAs of nodes present in the site 204. In the context of FIG. 8, the first gateway address of the BEB 210 is an IP address 100.1.1.2 for the service identified as Service-1 and a range of IP addresses 20.1.1.0/24 contains available L3 DAs for reaching the CEs located in the site 204. The BEB/VTEP 208 also associates the VRF-C and the Service-2 with a second routing table entry comprising a second gateway address of the VTEP 212 and a second set of L3 DAs of nodes present in the site 206. In the context of FIG. 8, the second gateway address of the VTEP 212 is an IP address 200.1.1.2 for the service identified as Service-2 and a range of IP addresses 30.1.1.0/24 contains available L3 DAs for reaching the CEs located in the site 206. It may be observed that, though Service-1 and Service-2 relate to the transport of packets over L2 backbone networks using distinct technologies, the manner in which VRFs, service identifiers and routing table entries are stored in the edge network nodes, such as the BEB/VTEP 208 and the BEBs or previous Figures remains the same.

The BEB 210 associates the VRF-C and the Service-1 with a third routing table entry comprising a third gateway address of the BEB/VTEP 208 and a third set of L3 DAs of nodes present in the sites 202 and 206. In the context of FIG. 8, the third gateway address of the BEB/VTEP 208 is an IP address 100.1.1.1 for the service identified as Service-1. The third set comprises a range of IP addresses 10.1.1.0/24 that are available L3 DAs for reaching the CEs located in the site 202 and, in addition, the range of IP addresses 30.1.1.0/24 for reaching the CEs located in the site 206. The BEB 210 may in an alternative embodiment store two (2) distinct routing table entries, both of which would associate the VRF-C with the Service-1, with the third gateway address of the BEB/VTEP 208. One of these routing table entries would associate these information elements with the range of IP addresses 10.1.1.0/24 and the other one would associate these information elements with the range of IP addresses 30.1.1.0/24.

The VTEP 212 associates the VRF-C and the Service-2 with a fourth routing table entry comprising a fourth gateway address of the BEB/VTEP 208 and a fourth set of L3 DAs of nodes present in the sites 202 and 204. In the context of FIG. 8, the fourth gateway address of the BEB/VTEP 208 is an IP address 200.1.1.1 for the service identified as Service-2. The fourth set of L3 DAs comprises the range of IP addresses 10.1.1.0/24 for reaching the CEs located in the site 202 and, in addition, the range of IP addresses 20.1.1.0/24 for reaching the CEs located in the site 204. Once again, the VTEP 212 may alternatively store two (2) distinct routing table entries with these information elements.

When receiving an outgoing packet from the site 202, the BEB/VTEP 208 maps a L3 DA contained in a header of the received outgoing packet with set of L3 DAs contained in one of the first and second routing table entries to select the proper service identifier. Encapsulation of the outgoing packet and its routing in a tunnel toward either of the BEB 210 or the VTEP 212 is performed in the same manner as expressed in the foregoing description of the previous Figures.

When receiving an outgoing packet from the site 204, the BEB 210 performs the same or equivalent operations. The same or equivalent operations are also performed at the VTEP 212 when receiving an outgoing packet from the site 206. Exchange of packets between the sites 204 and 206 may however be handled differently by the BEB/VTEP 208.

In an embodiment, the VTEP 212 receives an outgoing packet from a CE present in the site 206. The outgoing packet comprises a header having:
A L2 SA designating the CE,
A L3 SA designating the CE, for example 30.0.0.5,
A L2 DA designating the VTEP 212,
A L3 DA designating another CE present in the site 204, for example 20.0.0.7, and
A TTL counter for the outgoing packet.

Because the L2 DA designates its own MAC address, the VTEP 212 performs a route lookup to forward the outgoing packet. The VTEP 212 encapsulates the outgoing packet in a tunnel by adding an outer header that designates the Service-2 and a L2 DA designating the BEB/VTEP 208. Given that the service identifier is the Service-2, the VTEP 212 forwards the outgoing tunnel packet over the VxLAN 216.

The BEB/VTEP 208 receives the now incoming tunnel packet, removes the outer header and verifies the L3 DA. In the present example, the L3 DA is 20.0.0.7, which is in the range 20.1.1.0/24 of available L3 DAs for reaching the CEs located in the site 204. The packet becomes an outgoing packet again. Based on the contents of its first routing table entry, the BEB/VTEP 208 associates this packet to the VRF-C and to the Service-1. The BEB/VTEP 208 places the packet in a new tunnel by adding a new outer header to the packet, the new outer header designating the Service-1 and including a L2 DA designating the BEB 210. Given that the service identifier is the Service-1, the BEB/VTEP 208 forwards the outgoing tunnel packet over the SPB network 214 toward the BEB 210. It may be noted that the TTL counter may be decremented by each one of the VTEP 212, the BEB/VTEP 208 and the BEB 210.

Forwarding a packet from the site 204 to the site 206 may be performed in a similar manner

### Routing Tables Overview

The following Table I summarizes the associations of VRFs, service identifiers and routing table entries in the BEBs 112 and 114 for FIGS. 1 and 4-7.

TABLE I

| | | | Routing table entry | | Routing table entry | |
|---|---|---|---|---|---|---|
| | | | in BEB 112 | | in BEB 114 | |
| FIG. | VRF | Service ID | DA | GW Address | DA | GW Address |
| FIG. 1 | VRF-A | ISID-1000 | 115.0.0.0/8 | 100.0.0.2 | 15.0.0.0/8 | 100.0.0.1 |
| | VRF-B | ISID-2000 | 116.0.0.0/8 | 200.0.0.2 | 16.0.0.0/8 | 200.0.0.1 |
| FIG. 4 | VRF-A | ISID-3000 | — | — | 201.0.0.0/8 | 123.0.0.1 |
| | VRF-B | ISID-4000 | 103.0.0.0/8 | 223.0.0.2 | — | — |
| FIG. 5 | VRF-A | ISID-5000 | 207.0.0.0/8 | 123.0.0.2 | 207.0.0.0/8 | 123.0.0.1 |
| | VRF-B | ISID-6000 | 212.0.0.0/8 | 223.0.0.2 | 212.0.0.0/8 | 223.0.0.1 |
| FIG. 6 | VRF-A | ISID-7000 | 115.0.0.0/8 | 100.0.0.2 | 15.0.0.0/8 | 100.0.0.1 |
| | | ISID-8000 | 115.0.0.0/8 | 200.0.0.2 | 15.0.0.0/8 | 200.0.0.1 |
| FIG. 7 | VRF-A | ISID-9000 | 20.0.0.0/24 | 100.0.0.2 | 10.0.0.0/24 | 100.0.0.1 |
| | | | 30.0.0.0/24 | 100.0.0.3 | 30.0.0.0/24 | 100.0.0.3 |

Though not shown on Table I, as expressed hereinabove, the BEB 118 of FIG. 7 may contain, for reaching the CEs of the VLAN 102, a routing table entry having a DA range of 10.0.0.0/24 with a GW address of 100.0.0.1, the BEB 118 further having, for reaching the CEs of the VLAN 104, a routing table entry having a DA range of 30.0.0.0/24 with a GW address of 100.0.0.3. In the BEB 118, these routing table entries are associated with the VRF-A and with the ISID-9000.

The following Table II summarizes the associations of VRFs, service identifiers and routing table entries in the BEB/VTEP 208, the BEB 210 and the VTEP 212 for FIG. 8

TABLE II

| | | Routing table entry | | Routing table entry | | Routing table entry | |
|---|---|---|---|---|---|---|---|
| | | in BEB/VTEP 208 | | in BEB 210 | | in VTEP 212 | |
| VRF | Service ID | DA | GW Address | DA | GW Address | DA | GW Address |
| VRF-C | Service-1 | 20.1.1.0/24 | 100.1.1.2 | 10.1.1.0/24 | 100.1.1.1 | — | — |
| | | | | 30.1.1.0/24 | | | |
| | Service-2 | 30.1.1.0/24 | 200.1.1.2 | — | — | 10.1.1.0/24 | 200.1.1.1 |
| | | | | | | 20.1.1.0/24 | |

It should be expressly understood that implementations for the edge network nodes, for example the BEBs 112, 114, 118 and 210, the BEB/VTEP 208 and the VTEP 212 are provided for illustration purposes only. As such, those skilled in the art will easily appreciate other specific implementational details for the edge network nodes. As such, by no means, examples provided herein above are meant to limit the scope of the present technology.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology. It will also be understood that a particular embodiment of the edge network node may implement any one or more of the general L3 VPN definition illustrated in the description of FIG. 1, the data forwarding illustrated in the description of FIG. 2, the service architecture illustrated in the description of FIG. 3, the router gateway illustrated in the description of FIG. 4, the virtual router redundancy protocol illustrated in the description of FIG. 5, the equal cost multi path illustrated in the description of FIG. 6, the multiple tunnels illustrated in the description of FIG. 7, and the routing between different types of services illustrated in the description of FIG. 8.

As such, the methods and systems implemented in accordance with some non-limiting embodiments of the present technology can be represented as follows, presented in numbered clauses.
[Clause 1] A method of configuring a service at an edge network node, comprising:

defining, at the edge network node, a first virtualized routing and forwarding (VRF) instance, the first VRF instance being defined for a first customer;

defining, at the edge network node, a first service identifier; and

associating, at the edge network node, (i) the first VRF instance with (ii) the first service identifier and with (iii) a first routing table entry, the first routing table entry comprising a first set of destination IP addresses and a first backbone IP address, the first backbone IP address being an address of a first peer edge network node.
[Clause 2] The method of clause 1, further comprising:

associating, at the edge network node, (i) the first VRF instance with (ii) the first service identifier, with (iii) the first routing table entry and with (iv) a second routing table entry, the second routing table entry comprising a second set of destination IP addresses and a second backbone IP address, the second backbone IP address being an address of a second peer edge network node.
[Clause 3] The method of any one of clauses 1 or 2, further comprising:

defining, at the edge network node, a second service identifier; and

associating, at the edge network node, (i) the first VRF instance with (ii) the second service identifier and with (iii) a third routing table entry, the third routing table entry comprising the first set of destination IP addresses and a third backbone IP address, the third backbone IP address being an address of the first peer edge network node.
[Clause 4] The method of any one of clauses 1 to 3, further comprising:

defining, at the edge network node, a third service identifier; and

associating, at the edge network node, (i) the first VRF instance with (ii) the third service identifier and with (iii) a fourth routing table entry, the fourth routing table entry comprising a third set of destination IP addresses and a fourth backbone IP address, the fourth backbone IP address being an address of a third peer edge network node.
[Clause 5] The method of any one of clauses 1 to 4, further comprising:

associating, at the edge network node, (i) the first VRF instance with (ii) the first service identifier, with (iii) the first routing table entry and with (iv) a fifth routing table entry, the fifth routing table entry comprising a fourth set of destination IP addresses and the first backbone IP address.
[Clause 6] The method of any one of clauses 1 to 5, further comprising:

defining, at the edge network node, a second VRF instance, the second VRF instance being defined for a second customer;

defining, at the edge network node, a fourth service identifier; and

associating, at the edge network node, (i) the second VRF instance with (ii) the fourth service identifier and with (iii) a sixth routing table entry, the sixth routing table entry comprising a fifth set of destination IP addresses and a fifth backbone IP address, the fifth backbone IP address being an address of the first peer edge network node.
[Clause 7] A method of configuring an Internet access service at an edge network node, comprising:

defining, at the edge network node, a fifth service identifier and a sixth service identifier;

associating, at the edge network node, (i) the fifth service identifier with (ii) a first service access port for a third customer;

defining, at the edge network node, a fourth VRF instance, the fourth VRF instance being defined for a fourth customer; and

associating, at the edge network node, (i) the fourth VRF instance with (ii) the sixth service identifier, with (iii) a second service access port for the fourth customer and with (iv) a seventh routing table entry, the seventh routing table entry comprising a sixth set of destination IP addresses and a first gateway address of a first Internet service provider.
[Clause 8] A method of configuring an Internet access service at an edge network node, comprising:

defining, at the edge network node, a fifth virtualized routing and forwarding (VRF) instance, the fifth VRF instance being defined for a fifth customer;

defining, at the edge network node, a sixth VRF instance, the sixth VRF instance being defined for a sixth customer;

defining, at the edge network node, a seventh service identifier and an eighth service identifier;

associating, at the edge network node, (i) the fifth VRF instance with (ii) the seventh service identifier, with (iii) a third service access port for the fifth customer, and with (iv) a ninth routing table entry, the ninth routing table entry comprising a seventh set of destination IP addresses and a second gateway address of a second Internet service provider;

associating, at the edge network node, (i) the sixth VRF instance with (ii) the eighth service identifier, with (iii) a fourth service access port for the sixth customer, and with (iv) a tenth routing table entry, the tenth routing table entry comprising an eighth set of destination IP addresses and a third gateway address of one of the second Internet service provider and a third Internet service provider;

configuring, at the edge network node, a first virtual IP address for the fifth VRF and a second virtual IP address for the sixth VRF;

assigning, at the edge network node, one of the edge network node and a fourth peer edge network node as a first master for the fifth VRF; and

assigning, at the edge network node, one of the edge network node and the fourth peer edge network node as a second master for the sixth VRF.
[Clause 9] The method of any one of clauses 1 to 6, further comprising:

receiving, at the edge network node, from the first customer, a first outgoing packet comprising a first header, the first header comprising a first layer 3 destination address (DA) designating a first distant node;

mapping, at the edge network node, the first layer 3 DA to the first set of destination IP addresses;

encapsulating, at the edge network node, the first outgoing packet in a first outgoing tunnel packet by adding a first outer header to the first outgoing packet, the first outer header comprising the first service identifier; and

sending the first outgoing tunnel packet, from the edge network node, over a backbone network in accordance with the first service identifier.
[Clause 10] The method of clause 9, further comprising:
   if the first service identifier designates a layer 2 backbone network:
      acquiring, at the edge network node, a first layer 2 address corresponding to the first backbone IP address, and
      inserting the first layer 2 address in the first outer header;
   if the first service identifier designates a layer 3 backbone network, inserting the first backbone IP address in the first outer header.
[Clause 11] The method of any one of clauses 2 to 10, further comprising:
   receiving, at the edge network node, from the first customer, a second outgoing packet comprising a second header, the second header comprising a second layer 3 DA designating a second distant node;
   mapping, at the edge network node, the second layer 3 DA to one of the first and second sets of destination IP addresses to select one of the first and second backbone IP addresses;
   if the first service identifier designates a layer 3 backbone network:
      defining, at the edge network node, a second outer header comprising (i) the first service identifier and (ii) the selected one of the first and second backbone IP addresses;
   if the first service identifier designates a layer 2 backbone network:
      acquiring, at the edge network node, a second layer 2 address corresponding to selected one of the first and second backbone IP addresses, and
      defining, at the edge network node, a second outer header comprising (i) the first service identifier and (ii) the second layer 2 address;
   encapsulating, at the edge network node, the second outgoing packet in a second outgoing tunnel packet by adding the second outer header to the second outgoing packet; and
   sending the second outgoing tunnel packet, from the edge network node, over the backbone network.
[Clause 12] The method of any one of clauses 3 to 11, further comprising:
   receiving, at the edge network node, from the first customer, a third outgoing packet comprising a third header, the third header comprising a third layer 3 DA designating a third distant node;
   mapping, at the edge network node, the third layer 3 DA to the first set of destination IP addresses;
   using, at the edge network node, a load balancing protocol to select one of the first and second service identifiers and to select a corresponding one of the first and third backbone IP addresses;
   if the selected service identifier designates a layer 3 backbone network:
      defining, at the edge network node, a third outer header comprising (i) the selected one of the first and third backbone IP addresses and (ii) the selected one of the first and second service identifiers;
   if the selected service identifier designates a layer 2 backbone network:
      acquiring, at the edge network node, a third layer 2 address corresponding to the selected one of the first and third backbone IP addresses, and
      defining, at the edge network node, a third outer header comprising (i) the third layer 2 address and (ii) the selected one of the first and second service identifiers;
   encapsulating, at the edge network node, the third outgoing packet in a third outgoing tunnel packet by adding the third outer header to the third outgoing packet; and
   sending the third outgoing tunnel packet, from the edge network node, over a backbone network in accordance with the selected service identifier.
[Clause 13] The method of any one of clauses 4 to 12, further comprising:
   receiving, at the edge network node, from the first customer, a fourth outgoing packet comprising a fourth header, the fourth header comprising a fourth layer 3 DA designating a fourth distant node;
   mapping, at the edge network node, the fourth layer 3 DA to one of the first and third sets of destination IP addresses to select one of the first and fourth backbone IP addresses and to select a corresponding one of the first and third service identifiers;
   if the selected service identifier designates a layer 3 backbone network:
      defining, at the edge network node, a fourth outer header comprising (i) the selected service identifier and (ii) the selected one of the first and fourth backbone IP addresses;
   if the selected service identifier designates a layer 2 backbone network:
      acquiring, at the edge network node, a fourth layer 2 address corresponding to selected one of the first and fourth backbone IP addresses, and
      defining, at the edge network node, a fourth outer header comprising (i) the selected service identifier and (ii) the fourth layer 2 address;
   encapsulating, at the edge network node, the fourth outgoing packet in a fourth outgoing tunnel packet by adding the fourth outer header to the fourth outgoing packet; and
   sending the fourth outgoing tunnel packet, from the edge network node, over a backbone network in accordance with the selected service identifier.
[Clause 14] The method of clause 7, further comprising:
   receiving, at the edge network node, on the first service access port for the third customer, a fifth outgoing packet comprising a fifth header, the fifth header comprising a first layer 2 DA and a fifth layer 3 DA designating a first Internet resource;
   associating, at the edge network node, the fifth outgoing packet to the fifth service identifier based on the first service access port;
   if the fifth service identifier designates a layer 3 backbone network:
      defining, at the edge network node, a fifth outer header comprising (i) the fifth service identifier and (ii) the fifth layer 3 DA;
   if the fifth service identifier designates a layer 2 backbone network:
      defining, at the edge network node, a fifth outer header comprising (i) the fifth service identifier and (ii) the first layer 2 DA;
   encapsulating, at the edge network node, the fifth outgoing packet in a fifth outgoing tunnel packet by adding the fifth outer header to the fifth outgoing packet; and
   sending the fifth outgoing tunnel packet, from the edge network node, over a backbone network in accordance with the fifth service identifier.
[Clause 15] The method of any one of clauses 7 or 14, further comprising:
   receiving, at the edge network node, on the second service access port for the fourth customer, a sixth outgoing packet comprising a sixth header, the sixth header comprising a sixth layer 3 DA designating a second Internet resource;
   associating, at the edge network node, the sixth outgoing packet to the sixth service identifier based on the second service access port;
   verifying, at the edge network node, that the sixth layer 3 DA maps to the sixth set of destination IP addresses; and
   if the sixth layer 3 DA maps to the sixth set of destination IP addresses, routing the sixth outgoing packet based on the sixth layer 3 DA.
[Clause 16] The method of clause 8, further comprising:
   receiving, at the edge network node, on the third service access port for the fifth customer, a seventh outgoing packet comprising a seventh header, the seventh header comprising a second layer 2 DA and a seventh layer 3 DA designating a third Internet resource;
   associating, at the edge network node, the seventh outgoing packet to the seventh service identifier based on the third service access port;
   if edge network node is the first master for the fifth VRF:
      verifying, at the edge network node, that the seventh layer 3 DA maps to the seventh set of destination IP addresses; and
      if the seventh layer 3 DA maps to the seventh set of destination IP addresses, routing the seventh outgoing packet based on the seventh layer 3 DA;
   if the fourth peer edge network node is the first master for the fifth VRF and if the seventh service identifier designates a layer 3 backbone network:
      defining, at the edge network node, a sixth outer header comprising (i) the seventh service identifier and (ii) the seventh layer 3 DA,
      encapsulating, at the edge network node, the sixth outgoing packet in a sixth outgoing tunnel packet by adding the sixth outer header to the sixth outgoing packet, and
      sending the sixth outgoing tunnel packet, from the edge network node, over a backbone network in accordance with the seventh service identifier;
   if the fourth peer edge network node is the first master for the fifth VRF and if the seventh service identifier designates a layer 2 backbone network:
      defining, at the edge network node, a sixth outer header comprising (i) the seventh service identifier and (ii) the second layer 2 DA,
      encapsulating, at the edge network node, the sixth outgoing packet in a sixth outgoing tunnel packet by adding the sixth outer header to the sixth outgoing packet, and
      sending the sixth outgoing tunnel packet, from the edge network node, over a backbone network in accordance with the seventh service identifier.
[Clause 17] The method of any one of clauses 8 or 16, further comprising:
   detecting, at the edge network node, that the fourth peer edge network node is not available;
   assigning, at the edge network node, the edge network node as the first master for the fifth VRF; and
   assigning, at the edge network node, the edge network node as the second master for the sixth VRF.
[Clause 18] An edge network node, comprising:
   a local port configured for exchanging packets with a first site of a first customer;
   a network port configured for sending packets over a backbone network;
   a memory device configured to store service information and routing information;
   a processor operatively connected with the local port and with the network port, the processor being operative to read and write into the memory device, the processor being configured to:
   define a first virtualized routing and forwarding (VRF) instance, the first VRF instance being defined for the first customer;
   define a first service identifier; and
   store in the memory device an association of (i) the first VRF instance with (ii) the first service identifier and with (iii) a first routing table entry, the first routing table entry comprising a first set of destination IP addresses and a first backbone IP address, the first backbone IP address being an address of a first peer edge network node
[Clause 19] The edge network node of clause 18, wherein the processor is further configured to:
   locate, in an outgoing packet received at the local port, a first header comprising a first layer 3 destination address (DA) designating a first distant node;
   associate the first outgoing packet with the first VRF instance by mapping the first layer 3 DA to the first set of destination IP addresses;
   encapsulate the first outgoing packet in a first outgoing tunnel packet by adding a first outer header to the first outgoing packet, the first outer header comprising the first service identifier and the first backbone IP address;
   request the network port to send the first outgoing tunnel packet over a backbone network in accordance with the first service identifier.
[Clause 20] The edge network node of any one of clauses 18 or 19, wherein the processor is further configured to:
   acquire a first layer 2 address corresponding to the first backbone IP address;
   locate, in an outgoing packet received at the local port, a first header comprising a first layer 3 destination address (DA) designating a first distant node;
   associate the first outgoing packet with the first VRF instance by mapping the first layer 3 DA to the first set of destination IP addresses;
   encapsulate the first outgoing packet in a first outgoing tunnel packet by adding a first outer header to the first outgoing packet, the first outer header comprising the first service identifier and the first layer 2 address;
   request the network port to send the first outgoing tunnel packet over a backbone network in accordance with the first service identifier.
[Clause 21] The edge network node of any one of clauses 18 to 20, further comprising:
   a service provisioning interface;
   a service manager operable to receive and parse service information from the service provisioning interface and to send the service information to the processor.
[Clause 22] The edge network node of clause 21, wherein the service provisioning interface is connected to an operator interface.
[Clause 23] The edge network node of any one of clauses 21 or 22, wherein the service manager is configured to inform the processor of a service activation and of a service deactivation.
[Clause 24] The edge network node of any one of clauses 21 to 23, wherein the service manager is configured to delete any part of the service information and to inform the processor of the deletion.
[Clause 25] The edge network node of any one of clauses 18 to 24, wherein the processor is further configured to define a service access port and to associate a packet received on this service access port to a corresponding service instance.
[Clause 26] The edge network node of any one of clauses 18 to 25, further comprising a non-transitory storage medium having stored thereon machine executable code for performing, when running on the processor, the method in accordance with any one of claims 1 to 17.

The edge network node mentioned in clauses 18 to 25 may, without limitation, include one or more of the BEB 112, the BEB 114, the BEB 118, the BEB/VTEP 208, the BEB 210 and the VTEP 212. The processor mentioned in clauses 18 to 25 may comprise a single processor or a plurality of cooperating processors. This processor or the cooperating processors may be programmed to effect the various operations of the clauses 1 to 17. In some embodiments, the processor or the cooperating processors may be programmed to effect all of these operations. In some other embodiments, the processor or the cooperating processors may be programmed to effect a subset of these operations.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The packets may be sent and received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method of configuring a service at an edge network node, comprising:
defining, at the edge network node, a first virtualized routing and forwarding (VRF) instance, the first VRF instance being defined for a first customer;
defining, at the edge network node, a first service identifier; and
associating, at the edge network node, (i) the first VRF instance with (ii) the first service identifier and with (iii) a first routing table entry, the first routing table entry comprising a first set of destination IP addresses and a first backbone IP address, the first backbone IP address being an address of a first peer edge network node.

2. The method of claim 1, further comprising:
associating, at the edge network node, (i) the first VRF instance with (ii) the first service identifier, with (iii) the first routing table entry and with (iv) a second routing table entry, the second routing table entry comprising a second set of destination IP addresses and a second backbone IP address, the second backbone IP address being an address of a second peer edge network node.

3. The method of claim 1, further comprising:
defining, at the edge network node, a second service identifier; and
associating, at the edge network node, (i) the first VRF instance with (ii) the second service identifier and with (iii) a third routing table entry, the third routing table entry comprising the first set of destination IP addresses and a third backbone IP address, the third backbone IP address being an address of the first peer edge network node.

4. The method of claim 1, further comprising:
defining, at the edge network node, a third service identifier; and
associating, at the edge network node, (i) the first VRF instance with (ii) the third service identifier and with (iii) a fourth routing table entry, the fourth routing table entry comprising a third set of destination IP addresses and a fourth backbone IP address, the fourth backbone IP address being an address of a third peer edge network node.

5. The method of claim 1, further comprising:
associating, at the edge network node, (i) the first VRF instance with (ii) the first service identifier, with (iii) the first routing table entry and with (iv) a fifth routing table entry, the fifth routing table entry comprising a fourth set of destination IP addresses and the first backbone IP address.

6. The method of claim 1, further comprising:
defining, at the edge network node, a second VRF instance, the second VRF instance being defined for a second customer;
defining, at the edge network node, a fourth service identifier; and
associating, at the edge network node, (i) the second VRF instance with (ii) the fourth service identifier and with (iii) a sixth routing table entry, the sixth routing table entry comprising a fifth set of destination IP addresses and a fifth backbone IP address, the fifth backbone IP address being an address of the first peer edge network node.

7. A method of configuring an Internet access service at an edge network node, comprising:
defining, at the edge network node, a fifth service identifier and a sixth service identifier;
associating, at the edge network node, (i) the fifth service identifier with (ii) a first service access port for a third customer;
defining, at the edge network node, a fourth VRF instance, the fourth VRF instance being defined for a fourth customer; and
associating, at the edge network node, (i) the fourth VRF instance with (ii) the sixth service identifier, with (iii) a second service access port for the fourth customer and with (iv) a seventh routing table entry, the seventh routing table entry comprising a sixth set of destination IP addresses and a first gateway address of a first Internet service provider.

8. A method of configuring an Internet access service at an edge network node, comprising:
defining, at the edge network node, a fifth virtualized routing and forwarding (VRF) instance, the fifth VRF instance being defined for a fifth customer;
defining, at the edge network node, a sixth VRF instance, the sixth VRF instance being defined for a sixth customer;
defining, at the edge network node, a seventh service identifier and an eighth service identifier;
associating, at the edge network node, (i) the fifth VRF instance with (ii) the seventh service identifier, with (iii) a third service access port for the fifth customer, and with (iv) a ninth routing table entry, the ninth routing table entry comprising a seventh set of destination IP addresses and a second gateway address of a second Internet service provider;
associating, at the edge network node, (i) the sixth VRF instance with (ii) the eighth service identifier, with (iii) a fourth service access port for the sixth customer, and with (iv) a tenth routing table entry, the tenth routing table entry comprising an eighth set of destination IP addresses and a third gateway address of one of the second Internet service provider and a third Internet service provider;
configuring, at the edge network node, a first virtual IP address for the fifth VRF and a second virtual IP address for the sixth VRF;
assigning, at the edge network node, one of the edge network node and a fourth peer edge network node as a first master for the fifth VRF; and
assigning, at the edge network node, one of the edge network node and the fourth peer edge network node as a second master for the sixth VRF.

9. The method of claim 1, further comprising:
receiving, at the edge network node, from the first customer, a first outgoing packet comprising a first header, the first header comprising a first layer 3 destination address (DA) designating a first distant node;
mapping, at the edge network node, the first layer 3 DA to the first set of destination IP addresses;
encapsulating, at the edge network node, the first outgoing packet in a first outgoing tunnel packet by adding a first outer header to the first outgoing packet, the first outer header comprising the first service identifier; and
sending the first outgoing tunnel packet, from the edge network node, over a backbone network in accordance with the first service identifier.

10. The method of claim 9, further comprising:
if the first service identifier designates a layer 2 backbone network:
acquiring, at the edge network node, a first layer 2 address corresponding to the first backbone IP address, and
inserting the first layer 2 address in the first outer header;
if the first service identifier designates a layer 3 backbone network, inserting the first backbone IP address in the first outer header.

11. The method of claim 2, further comprising:
receiving, at the edge network node, from the first customer, a second outgoing packet comprising a second header, the second header comprising a second layer 3 DA designating a second distant node;
mapping, at the edge network node, the second layer 3 DA to one of the first and second sets of destination IP addresses to select one of the first and second backbone IP addresses;
if the first service identifier designates a layer 3 backbone network:
defining, at the edge network node, a second outer header comprising (i) the first service identifier and (ii) the selected one of the first and second backbone IP addresses;
if the first service identifier designates a layer 2 backbone network:
acquiring, at the edge network node, a second layer 2 address corresponding to selected one of the first and second backbone IP addresses, and
defining, at the edge network node, a second outer header comprising (i) the first service identifier and (ii) the second layer 2 address;
encapsulating, at the edge network node, the second outgoing packet in a second outgoing tunnel packet by adding the second outer header to the second outgoing packet; and
sending the second outgoing tunnel packet, from the edge network node, over the backbone network.

12. The method of claim 3, further comprising:
receiving, at the edge network node, from the first customer, a third outgoing packet comprising a third header, the third header comprising a third layer 3 DA designating a third distant node;
mapping, at the edge network node, the third layer 3 DA to the first set of destination IP addresses;
using, at the edge network node, a load balancing protocol to select one of the first and second service identifiers and to select a corresponding one of the first and third backbone IP addresses;
if the selected service identifier designates a layer 3 backbone network:
defining, at the edge network node, a third outer header comprising (i) the selected one of the first and third backbone IP addresses and (ii) the selected one of the first and second service identifiers;
if the selected service identifier designates a layer 2 backbone network:
acquiring, at the edge network node, a third layer 2 address corresponding to the selected one of the first and third backbone IP addresses, and
defining, at the edge network node, a third outer header comprising (i) the third layer 2 address and (ii) the selected one of the first and second service identifiers;
encapsulating, at the edge network node, the third outgoing packet in a third outgoing tunnel packet by adding the third outer header to the third outgoing packet; and
sending the third outgoing tunnel packet, from the edge network node, over a backbone network in accordance with the selected service identifier.

13. The method of claim 4, further comprising:
receiving, at the edge network node, from the first customer, a fourth outgoing packet comprising a fourth header, the fourth header comprising a fourth layer 3 DA designating a fourth distant node;
mapping, at the edge network node, the fourth layer 3 DA to one of the first and third sets of destination IP addresses to select one of the first and fourth backbone IP addresses and to select a corresponding one of the first and third service identifiers;
if the selected service identifier designates a layer 3 backbone network:
defining, at the edge network node, a fourth outer header comprising (i) the selected service identifier and (ii) the selected one of the first and fourth backbone IP addresses;
if the selected service identifier designates a layer 2 backbone network:
acquiring, at the edge network node, a fourth layer 2 address corresponding to selected one of the first and fourth backbone IP addresses, and
defining, at the edge network node, a fourth outer header comprising (i) the selected service identifier and (ii) the fourth layer 2 address;
encapsulating, at the edge network node, the fourth outgoing packet in a fourth outgoing tunnel packet by adding the fourth outer header to the fourth outgoing packet; and
sending the fourth outgoing tunnel packet, from the edge network node, over a backbone network in accordance with the selected service identifier.

14. The method of claim 7, further comprising:
receiving, at the edge network node, on the first service access port for the third customer, a fifth outgoing packet comprising a fifth header, the fifth header comprising a first layer 2 DA and a fifth layer 3 DA designating a first Internet resource;
associating, at the edge network node, the fifth outgoing packet to the fifth service identifier based on the first service access port;
if the fifth service identifier designates a layer 3 backbone network:
defining, at the edge network node, a fifth outer header comprising (i) the fifth service identifier and (ii) the fifth layer 3 DA;
if the fifth service identifier designates a layer 2 backbone network:
defining, at the edge network node, a fifth outer header comprising (i) the fifth service identifier and (ii) the first layer 2 DA;
encapsulating, at the edge network node, the fifth outgoing packet in a fifth outgoing tunnel packet by adding the fifth outer header to the fifth outgoing packet; and
sending the fifth outgoing tunnel packet, from the edge network node, over a backbone network in accordance with the fifth service identifier.

15. The method of claim 7, further comprising:
receiving, at the edge network node, on the second service access port for the fourth customer, a sixth outgoing packet comprising a sixth header, the sixth header comprising a sixth layer 3 DA designating a second Internet resource;
associating, at the edge network node, the sixth outgoing packet to the sixth service identifier based on the second service access port;
verifying, at the edge network node, that the sixth layer 3 DA maps to the sixth set of destination IP addresses; and
if the sixth layer 3 DA maps to the sixth set of destination IP addresses, routing the sixth outgoing packet based on the sixth layer 3 DA.

16. The method of claim 8, further comprising:
receiving, at the edge network node, on the third service access port for the fifth customer, a seventh outgoing packet comprising a seventh header, the seventh header comprising a second layer 2 DA and a seventh layer 3 DA designating a third Internet resource;
associating, at the edge network node, the seventh outgoing packet to the seventh service identifier based on the third service access port;
if edge network node is the first master for the fifth VRF:
verifying, at the edge network node, that the seventh layer 3 DA maps to the seventh set of destination IP addresses; and
if the seventh layer 3 DA maps to the seventh set of destination IP addresses, routing the seventh outgoing packet based on the seventh layer 3 DA;
if the fourth peer edge network node is the first master for the fifth VRF and if the seventh service identifier designates a layer 3 backbone network:
defining, at the edge network node, a sixth outer header comprising (i) the seventh service identifier and (ii) the seventh layer 3 DA,
encapsulating, at the edge network node, the sixth outgoing packet in a sixth outgoing tunnel packet by adding the sixth outer header to the sixth outgoing packet, and
sending the sixth outgoing tunnel packet, from the edge network node, over a backbone network in accordance with the seventh service identifier;
if the fourth peer edge network node is the first master for the fifth VRF and if the seventh service identifier designates a layer 2 backbone network:
defining, at the edge network node, a sixth outer header comprising (i) the seventh service identifier and (ii) the second layer 2 DA,
encapsulating, at the edge network node, the sixth outgoing packet in a sixth outgoing tunnel packet by adding the sixth outer header to the sixth outgoing packet, and
sending the sixth outgoing tunnel packet, from the edge network node, over a backbone network in accordance with the seventh service identifier.

17. The method of claim 8, further comprising:
detecting, at the edge network node, that the fourth peer edge network node is not available;
assigning, at the edge network node, the edge network node as the first master for the fifth VRF; and
assigning, at the edge network node, the edge network node as the second master for the sixth VRF.

18. An edge network node, comprising:
a local port configured for exchanging packets with a first site of a first customer;
a network port configured for sending packets over a backbone network;
a memory device configured to store service information and routing information;
a processor operatively connected with the local port and with the network port, the processor being operative to read and write into the memory device, the processor being configured to:
define a first virtualized routing and forwarding (VRF) instance, the first VRF instance being defined for the first customer;
define a first service identifier; and
store in the memory device an association of (i) the first VRF instance with (ii) the first service identifier and with (iii) a first routing table entry, the first routing table entry comprising a first set of destination IP addresses and a first backbone IP address, the first backbone IP address being an address of a first peer edge network node

19. The edge network node of claim 18, wherein the processor is further configured to:
locate, in an outgoing packet received at the local port, a first header comprising a first layer 3 destination address (DA) designating a first distant node;
associate the first outgoing packet with the first VRF instance by mapping the first layer 3 DA to the first set of destination IP addresses;
encapsulate the first outgoing packet in a first outgoing tunnel packet by adding a first outer header to the first outgoing packet, the first outer header comprising the first service identifier and the first backbone IP address;
request the network port to send the first outgoing tunnel packet over a backbone network in accordance with the first service identifier.

20. The edge network node of claim 18, wherein the processor is further configured to:
acquire a first layer 2 address corresponding to the first backbone IP address;
locate, in an outgoing packet received at the local port, a first header comprising a first layer 3 destination address (DA) designating a first distant node;
associate the first outgoing packet with the first VRF instance by mapping the first layer 3 DA to the first set of destination IP addresses;
encapsulate the first outgoing packet in a first outgoing tunnel packet by adding a first outer header to the first outgoing packet, the first outer header comprising the first service identifier and the first layer 2 address;
request the network port to send the first outgoing tunnel packet over a backbone network in accordance with the first service identifier.

21. The edge network node of claim 18, further comprising:
a service provisioning interface;
a service manager operable to receive and parse service information from the service provisioning interface and to send the service information to the processor.

22. The edge network node of claim 21, wherein the service provisioning interface is connected to an operator interface.

23. The edge network node of claim 21, wherein the service manager is configured to inform the processor of a service activation and of a service deactivation.

24. The edge network node of claim 21, wherein the service manager is configured to delete any part of the service information and to inform the processor of the deletion.

25. The edge network node of claim 18, wherein the processor is further configured to define a service access port and to associate a packet received on this service access port to a corresponding service instance.

26. The method of claim 1, wherein the first service identifier designates a first packet transport service.

27. The method of claim 7, wherein the fifth service identifier designates a second packet transport service and wherein the sixth service identifier designates a third packet transport service.

28. The method of claim 8, wherein the seventh service identifier designates a fourth packet transport service and wherein the eighth service identifier designates a fifth packet transport service.

29. The edge network node of claim 18, wherein the first service identifier designates a first packet transport service.
